(19) United States
(12) Patent Application Publication
(10) Pub. No.: US 2026/0222721 A1
(43) Pub. Date: Jul. 30, 2026

(54) AIR CONDUCTION SPEAKERS AND EARPHONES

(71) Applicant: SHENZHEN SHOKZ CO., LTD., Shenzhen (CN)

(72) Inventors: Qianwen NIE, Shenzhen (CN); Chaowu LI, Shenzhen (CN); Jianing LIANG, Shenzhen (CN); Guolin XIE, Shenzhen (CN); Chunyi GAO, Shenzhen (CN); Xiaopeng YU, Shenzhen (CN); Yongjian LI, Shenzhen (CN); Fen YOU, Shenzhen (CN); Xin QI, Shenzhen (CN)

(73) Assignee: SHENZHEN SHOKZ CO., LTD., Shenzhen (CN)

(21) Appl. No.: 19/573,097

(22) Filed: Mar. 20, 2026

Related U.S. Application Data
(63) Continuation of application No. PCT/CN2024/095599, filed on May 27, 2024.

(51) Int. Cl. H04R 1/08; H01Q 1/27; H01Q 1/36; H01Q 1/52; H04R 1/10; H04R 7/18

(52) U.S. Cl. CPC H04R 1/08; H01Q 1/273; H01Q 1/36; H01Q 1/521; H04R 1/1041; H04R 1/1075; H04R 7/18; H04R 2400/11; H04R 2420/07

(57) ABSTRACT

The present disclosure relates to an air conduction speaker and an earphone. The air conduction speaker includes a diaphragm, a fixing ring, and a frame. The diaphragm includes a vibration body and an annular fixing portion connected to the vibration body and arranged around a periphery of the vibration body. The fixing ring is fixedly connected to the annular fixing portion and sleeved on the frame. A first connection length exists between the annular fixing portion and the fixing ring along an axial direction of the air conduction speaker. A second connection length exists between the annular fixing portion and the fixing ring along a radial direction of the air conduction speaker. The first connection length is greater than the second connection length. In this way, sound quality of the speaker is effectively improved, and an overall volume of the speaker is effectively reduced.

### CROSS REFERENCE TO RELATED APPLICATIONS

This application is a continuation of International Application No. PCT/CN2024/095599 filed on May 27, 2024, the entire contents of which are incorporated herein by reference.

### TECHNICAL FIELD

The present disclosure relates to the field of electronic device, and in particular, to an air conduction speaker and an earphone.

### BACKGROUND

With the continuous popularization of electronic devices, the electronic devices have become indispensable social and entertainment tools in people's daily lives, and people's requirements for the electronic devices also have become increasingly higher. The electronic devices such as earphones and smart glasses have also been widely used in people's daily lives. The electronic devices can be used in conjunction with terminal devices such as mobile phones and computers to provide users with an auditory feast. The size of the earphone greatly affects user experience. Therefore, as an important component for sound generation in the earphone, an air conduction speaker should have a small structural size while satisfying good sound quality to meet the requirements for miniaturization of the earphone. However, a traditional structural solution of air conduction speaker can't effectively solve the problem of degraded sound quality caused by reduction in the structural size of the air conduction speaker.

### SUMMARY

The present disclosure provides an air conduction speaker. The air conduction speaker includes: a diaphragm, a fixing ring, and a frame, wherein the diaphragm includes a vibration body and an annular fixing portion connected to the vibration body and arranged around a periphery of the vibration body; the fixing ring is fixedly connected to the annular fixing portion and sleeved on the frame; and a first connection length exists between the annular fixing portion and the fixing ring along an axial direction of the air conduction speaker and a second connection length exists between the annular fixing portion and the fixing ring along a radial direction of the air conduction speaker, wherein the first connection length is greater than the second connection length.

In some embodiments, a ratio of the first connection length to the second connection length is greater than 4.

In some embodiments, the first connection length is not less than 0.5 mm, or the second connection length is not greater than 0.20 mm.

In some embodiments, the fixing ring includes a cylindrical body sleeved on the frame, wherein a height of the cylindrical body along the axial direction is greater than a wall thickness of the cylindrical body along the radial direction; the annular fixing portion is fixedly connected to an inner circumferential surface or an outer circumferential surface of the cylindrical body to form the first connection length; the annular fixing portion is fixedly connected to an end face of the cylindrical body to form the second connection length; or the annular fixing portion is only fixedly connected to the inner circumferential surface or the outer circumferential surface of the cylindrical body, such that the second connection length is zero.

In some embodiments, a thickness of the annular fixing portion along the radial direction is less than the first connection length.

In some embodiments, a ratio of the height of the cylindrical body to the wall thickness of the cylindrical body is greater than 6.6, and a ratio of the first connection length to the height of the cylindrical body is greater than 0.4.

In some embodiments, the fixing ring further includes an annular flange protruding along the radial direction from the outer circumferential surface of the cylindrical body.

In some embodiments, a third connection length exists between the annular flange and the annular fixing portion along the radial direction of the air conduction speaker, and the third connection length is greater than zero.

In some embodiments, a ratio of a protruding distance of the annular flange relative to the outer circumferential surface of the cylindrical body to the wall thickness of the cylindrical body is between 0.66 and 1.0.

In some embodiments, the annular fixing portion is fixedly connected to the outer circumferential surface of the cylindrical body, and a thickness of the annular fixing portion along the radial direction is less than a protruding distance of the annular flange relative to the outer circumferential surface of the cylindrical body.

In some embodiments, the frame includes an insertion portion and a supporting portion connected to each other along the axial direction, wherein a size of the supporting portion along the radial direction is greater than a size of the insertion portion along the radial direction, thereby forming an annular step surface at a connection between the insertion portion and the supporting portion, wherein the insertion portion is inserted into the cylindrical body, and the annular flange is supported on the annular step surface.

In some embodiments, a glue groove is provided on the annular step surface, and the fixing ring covers the glue groove.

In some embodiments, the air conduction speaker further includes: a magnetic circuit assembly configured to form a magnetic gap, wherein the frame surrounds a periphery of the magnetic circuit assembly and is relatively fixed to the magnetic circuit assembly; and a voice coil, wherein one end of the voice coli is fixedly connected to the vibration body and the other end of the voice coli extends into the magnetic gap.

The present disclosure provides an earphone. The earphone includes a housing and the air conduction speaker according to any one of the above embodiments, wherein the air conduction speaker is accommodated inside the housing.

The present disclosure provides an earphone. The earphone includes: a housing assembly; and a microphone assembly, wherein the housing assembly is configured to form an accommodating space, the microphone assembly being disposed in the accommodating space; two sound inlet holes that connect the accommodating space with an exterior of the housing assembly are provided on the housing assembly, sound inlet ends of the two sound inlet holes being spaced apart from each other; a mounting groove is provided on an inner surface of the housing assembly, sound outlet ends of the two sound inlet holes communicating with the mounting groove; and the microphone assembly includes a sound guiding base and a microphone, wherein a sound guiding channel is provided on the sound guiding base, the sound guiding base is embedded in the mounting groove, a sound inlet end of the sound guiding channel communicates with the sound outlet ends of the two sound inlet holes within the mounting groove, and the microphone is configured to receive sound output from a sound outlet end of the sound guiding channel.

In some embodiments, the earphone further includes a circuit board, wherein the sound guiding base is disposed on a side of the circuit board facing the mounting groove, and the circuit board presses and fixes the sound guiding base in the mounting groove; the microphone is disposed on the other side of the circuit board away from the mounting groove; and a communication hole is provided on the circuit board, and the microphone communicates with the sound outlet end of the sound guiding channel through the communication hole.

In some embodiments, the microphone assembly further includes a sealing member disposed between the circuit board and the sound guiding base, and the sealing member is arranged around the sound outlet end of the sound guiding channel and a sound inlet end of the communication hole.

In some embodiments, an annular groove is provided on the circuit board or the sound guiding base, wherein the sealing member is disposed in the annular groove; and the sound outlet end of the sound guiding channel and the sound inlet end of the communication hole are located within an area enclosed by the annular groove.

In some embodiments, the sealing member is integrally formed with the sound guiding base and protrudes from the sound guiding base.

In some embodiments, the sound outlet ends of the two sound inlet holes and the sound inlet end of the sound guiding channel are oppositely spaced apart along a spacing direction of the sound guiding base and the two sound inlet holes.

In some embodiments, the sound outlet ends of the two sound inlet holes are located at a bottom of the mounting groove, wherein a first groove recessed in a direction away from the sound guiding base is provided at the bottom of the mounting groove, and the sound outlet ends of the two sound inlet holes communicate with each other through the first groove.

In some embodiments, a depth of the first groove is set to 0.25 to 0.55 mm.

In some embodiments, the earphone further includes an acoustic resistance mesh, wherein an annular step surface is reserved at the bottom of the mounting groove around the sound outlet ends of the two sound inlet holes and the first groove; the sound guiding base presses and fixes the acoustic resistance mesh on the annular step surface; and the acoustic resistance mesh further covers the sound outlet ends of the two sound inlet holes and the first groove.

In some embodiments, an extension direction of mesh holes of the acoustic resistance mesh is at least partially arranged to intersect the spacing direction.

In some embodiments, the acoustic resistance mesh includes at least two steel mesh layers spaced apart along the spacing direction.

In some embodiments, a second groove recessed in a direction away from the two sound inlet holes is provided on a side of the sound guiding base facing the two sound inlet holes, wherein the sound outlet ends of the two sound inlet holes communicate with each other through the second groove, and the sound inlet end of the sound guiding channel is provided in the second groove.

In some embodiments, an annular flange is provided on the side of the sound guiding base facing the two sound inlet holes, wherein the annular flange encloses to form the second groove, the annular flange is embedded in the mounting groove, and the annular flange presses and fixes the acoustic resistance mesh on the annular step surface.

In some embodiments, the sound guiding base is supported on the bottom of the mounting groove, and a projection of the first groove along the spacing direction falls within the second groove.

In some embodiments, a depth of the second groove is set to 0.2 to 0.5 mm.

In some embodiments, the earphone according to any one of the above embodiments, wherein a projection of the sound inlet end of the sound guiding channel along the spacing direction at least partially falls within a spacing area between the two sound inlet holes.

In some embodiments, the sound inlet hole includes an extended channel that connects the sound inlet end of the sound inlet hole with the sound outlet end of the sound inlet hole, wherein in a wearing state, at least a portion of the extended channel near an exterior of the housing assembly is inclined toward a rear side of a human body relative to a sagittal plane of the human body, wherein an angle between an extension direction of the extended channel and the sagittal plane is greater than or equal to 5° and less than or equal to 40°.

The present disclosure provides an earphone. The earphone includes: a core module; and an ear hook portion connected to the core module, wherein in a wearing state, the core module is located at a front side of an ear, and at least a portion of the ear hook portion is hooked on a rear side of the ear; the ear hook portion includes an elastic connector, an accommodating housing, and an elastic coating body, wherein one end of the elastic connector is connected to the core module, and the other end of the elastic connector is connected to the accommodating housing; the elastic coating body includes a first coating section and a second coating section, wherein at least a portion of the first coating section is molded to coat a periphery of the elastic connector, and at least a portion of the second coating section is sleeved to coat at least a portion of a periphery of the accommodating housing away from the elastic connector.

In some embodiments, the accommodating housing includes a first housing coated by the second coating section and a boss disposed at an end of a free end of the first housing away from the elastic connector; the second coating section is arranged in a bag shape and has an opening at a free end away from the elastic connector for inserting the first housing into the second coating section, wherein the opening is arranged around a periphery of a side circumferential wall of the boss.

In some embodiments, a ratio of a radial size of the boss to a maximum radial size of the first housing is between 0.4 and 0.7.

In some embodiments, an edge of the opening is in contact with a side circumferential wall of the boss, or a gap between the edge of the opening and the side circumferential wall of the boss is less than 0.2 mm.

In some embodiments, when viewed in a direction toward an outer end face of the boss, both the opening and the boss are circular.

In some embodiments, when viewed in a direction toward an outer end face of the boss, the first housing is circular, and a center of the first housing is concentric with a center of the boss, or a distance between the center of the first housing and the center of the boss is less than 5 mm.

In some embodiments, an outer surface of the free end of the first housing is reduced in an arc-shaped transition in a direction away from the elastic connector.

In some embodiments, the outer surface of the free end of the first housing is spherical.

In some embodiments, at the boss, an outer surface of the second coating section is flush with an outer end face of the boss, or the outer end face of the boss protrudes from the outer surface of the second coating section by a protruding height not greater than 3 mm.

In some embodiments, the accommodating housing further includes a second housing, wherein one end of the second housing is connected to the other end of the elastic connector, and the other end of the second housing is connected to an end of the first housing away from the boss to form an accommodating chamber, and the first coating section is further molded to coat a periphery of the second housing.

In some embodiments, the second housing includes a main part and an inserting part, wherein the main part is connected to the elastic connector; the inserting part is connected to an end of the main part facing the accommodating housing; a radial size of the inserting part is less than a radial size of the main part, thereby forming an annular step surface at a connection between the inserting part and the main part; the accommodating housing includes an open end, the inserting part is inserted into the accommodating housing from the open end, and the open end further abuts against the annular step surface; and at the open end, an outer surface of the accommodating housing and an outer surface of the main part transition smoothly.

In some embodiments, the earphone further includes glue at least filled between an outer surface of the first housing and the second coating section, wherein the glue is spaced apart from a circumferential side wall of the boss.

In some embodiments, the second coating section is attached to an outer wall of the first housing.

In some embodiments, in a natural state, a radial size of a coating space formed by the second coating section is less than a radial size of the first housing.

The present disclosure provides an earphone. The earphone includes an antenna pattern, the antenna pattern including a first antenna pattern and a second antenna pattern, wherein a feed point for receiving a feed signal is provided on the first antenna pattern; the first antenna pattern is bent along its extension direction to form a first semi-enclosed structure with a first opening; the second antenna pattern is coupled to the first antenna pattern to disperse current on the first antenna pattern; and when viewed in a direction toward a main surface of the first antenna pattern, a projection of the second antenna pattern in a direction opposite to an opening direction of the first antenna pattern at least partially overlaps with the first antenna pattern.

In some embodiments, an arc-to-chord ratio of the first antenna pattern is not less than 2.

In some embodiments, the first antenna pattern and the second antenna pattern are spaced apart, and a grounding point for grounding is provided on the second antenna pattern to serve as a parasitic branch of the first antenna pattern.

In some embodiments, at least a portion of the second antenna pattern is arranged in a wavy shape.

In some embodiments, at least a portion of the second antenna pattern is located inside the semi-enclosed structure.

In some embodiments, the first antenna pattern includes a first pattern portion and a second pattern portion arranged side by side and a third pattern portion connecting the first pattern portion and the second pattern portion; at least a portion of the second antenna pattern is arranged between the first pattern portion and the second pattern portion; and a projection of the second antenna pattern in a direction opposite to an opening direction of the first antenna pattern at least partially overlaps with the third pattern portion.

In some embodiments, at least a portion of the second antenna pattern is a touch pattern for detecting a touch signal.

In some embodiments, the second antenna pattern includes a main portion arranged in a block shape and an extension portion connected to the main portion and arranged in a wavy shape.

In some embodiments, the second antenna pattern is connected to the first antenna pattern with the feed point as a boundary point, and the feed point is configured to simultaneously provide the feed signal to the first antenna pattern and the second antenna pattern.

In some embodiments, the second antenna pattern is bent along an extension direction thereof to form a second semi-enclosed structure with a second opening, and a projection of the first antenna pattern in a direction opposite to an opening direction of the second antenna pattern at least partially overlaps with the second antenna pattern.

In some embodiments, in an area near the feed point, the first antenna pattern and the second antenna pattern are configured to extend away from each other starting from the feed point.

In some embodiments, a free end of the first antenna pattern and a free end of the second antenna pattern are arranged adjacent to each other; and in an area near the free end of the first antenna pattern and the free end of the second antenna pattern, the first antenna pattern and the second antenna pattern are configured to extend toward each other with their respective free ends as terminal points.

In some embodiments, a spacing distance between the free end of the first antenna pattern and the free end of the second antenna pattern is less than an opening width of the first antenna pattern and an opening width of the second antenna pattern.

In some embodiments, an arc-to-chord ratio of the second antenna pattern is not less than 2.

In some embodiments, the earphone further includes a touch pattern, wherein at least a portion of the touch pattern is arranged in the first semi-enclosed structure and/or the second semi-enclosed structure.

### BRIEF DESCRIPTION OF THE DRAWINGS

To more clearly illustrate the technical solutions in the embodiments of the present disclosure, the drawings used in the description of the embodiments will be briefly introduced below. Obviously, the drawings in the following description are only some embodiments of the present disclosure. For those of ordinary skill in the art, other drawings may be obtained based on these drawings without creative effort.

FIG. 1 is a schematic diagram illustrating a front contour of an ear of a user according to the present disclosure;

FIG. 2 is schematic diagram illustrating a lateral three-dimensional structure of an earphone according to some embodiments of the present disclosure;

FIG. 3 is a schematic diagram illustrating the earphone shown in FIG. 2 in a wearing state;

FIG. 4 is a schematic diagram illustrating an exploded structure of the earphone shown in FIG. 2;

FIG. 5 is a schematic diagram illustrating an exploded structure of an ear hook portion in the earphone shown in FIG. 2;

FIG. 6 is a schematic diagram illustrating a front structure of the ear hook portion in the earphone shown in FIG. 2 after an elastic coating body is removed;

FIG. 7 is a schematic diagram illustrating a structure of a partial cross-section A-A in the earphone shown in FIG. 2;

FIG. 8 is another schematic diagram illustrating a structure of the partial cross-section A-A in the earphone shown in FIG. 2;

FIG. 9 is another schematic diagram illustrating a lateral three-dimensional structure of the earphone shown in FIG. 2;

FIG. 10 is a schematic diagram illustrating a structure of a cross-section B-B in the earphone shown in FIG. 9;

FIG. 11 is a schematic diagram illustrating a structure of a second housing in the earphone shown in FIG. 4 according to some embodiments;

FIG. 12 is a schematic diagram illustrating an enlarged structure of a partial area C in the earphone shown in FIG. 9;

FIG. 13 is a schematic diagram illustrating a structure of a cross-section D-D of the second housing shown in FIG. 11;

FIG. 14 is a schematic diagram illustrating a radial cross-section of a speaker in the earphone shown in FIG. 4;

FIG. 15 is a schematic diagram illustrating an enlarged structure of a partial area E of the speaker shown in FIG. 14;

FIG. 16 is a schematic diagram illustrating an enlarged structure of a partial area F shown in FIG. 15;

FIG. 17 is a schematic diagram illustrating a structure of a relative positional relationship between a flexible covering layer and an antenna pattern according to a first embodiment;

FIG. 18 is a schematic diagram illustrating a structure of a relative positional relationship between a flexible covering layer and an antenna pattern according to a second embodiment;

FIG. 19 is a schematic diagram illustrating a structure of a relative positional relationship between a flexible covering layer and an antenna pattern according to a third embodiment;

FIG. 20 is a schematic diagram illustrating a structure of the antenna pattern shown in FIG. 17;

FIG. 21 is a schematic diagram illustrating a structure of the antenna pattern shown in FIG. 18; and

FIG. 22 is a schematic diagram illustrating a structure of the antenna pattern shown in FIG. 19.

### DETAILED DESCRIPTION

The present disclosure is described in further detail below in conjunction with the accompanying drawings and embodiments. It is specifically noted that the following embodiments are only used to illustrate the present disclosure, but do not limit the scope of the present disclosure. Similarly, the following embodiments are only part of the embodiments of the present disclosure rather than all embodiments. All other embodiments obtained by a person of ordinary skill in the art based on the embodiments of the present disclosure without creative efforts shall fall within the protection scope of the present disclosure.

Mention of “embodiment” in the present disclosure means that a particular feature, structure, or characteristic described in connection with the embodiment may be included in at least one embodiment of the present disclosure. A person skilled in the art explicitly and implicitly understands that the embodiments described in the present disclosure may be combined with other embodiments.

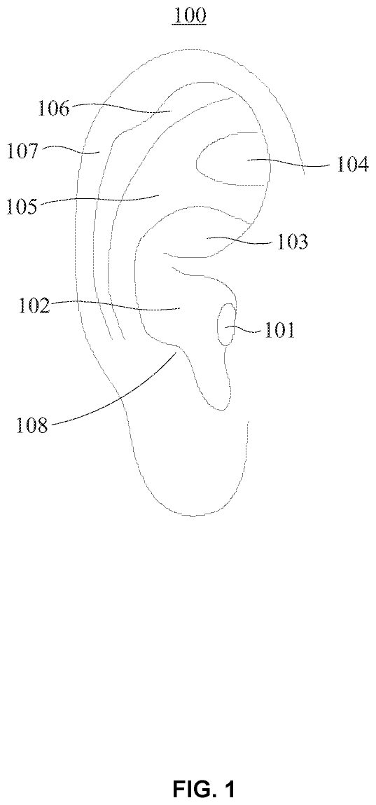

As described in connection with FIG. 1, an ear 100 of a user may include physiological parts such as an external acoustic meatus 101, an auricular cavity 102, a cymba concha 103, a triangular fossa 104, an antihelix 105, a scapha 106, a helix 107, a tragus 108, etc. Although the external acoustic meatus 101 has a certain depth and extends to an eardrum of the ear, for ease of description and in conjunction with FIG. 1, the external acoustic meatus 101 in the present disclosure specifically refers to an entrance (i.e., an ear hole) thereof away from the eardrum unless otherwise specified. Furthermore, physiological parts such as the auricular cavity 102, the cymba concha 103, the triangular fossa 104, etc., have a certain volume and depth, and the auricular cavity 102 is in direct communication with the external acoustic meatus 101, which can be simply considered that the aforementioned ear hole is located at a bottom of the auricular cavity 102.

Furthermore, different users may have individual differences, which results in dimensional differences in ears such as different shapes and sizes. For ease of description and to reduce (or even eliminate) the individual differences of the different users, a simulator including a head and ears (a left ear and a right ear) thereof may be manufactured based on ANSI: S3.36, S3.25 standard and IEC: 60318-7 standard, such as GRAS 45BC KEMAR series, HEAD Acoustics series, B&K 4128 series, or B&K 5128 series, to present a scenario where most users wear an earphone 10. Taking GRAS KEMAR as an example, the simulator for the ear may be any one of GRAS 45AC, GRAS 45BC, GRAS 45CC, or GRAS 43AG. Taking HEAD Acoustics as an example, the simulator for the ear may be any one of HMS II.3, HMS II.3 LN, or HMS II.3LN HEC. Therefore, in the present disclosure, descriptions such as “a user wears the earphone 10,” “the earphone 10 is in a wearing state,” “in the wearing state,” etc., refer to the earphone 10 described in the present disclosure being worn on the ear of the aforementioned simulator. Certainly, precisely because the different users have the individual differences, there may be certain differences when the earphone 10 is worn by the different users compared with when the earphone 10 is worn on the ear of the aforementioned simulator, but such differences should be tolerated.

It should be noted that in fields such as medicine and anatomy, three basic planes (e.g., a sagittal plane, a coronal plane, and a horizontal plane) and three basic axes (e.g., a sagittal axis, a coronal axis, and a vertical axis) of a human body may be defined. The sagittal plane refers to a plane perpendicular to the ground made along an anteroposterior direction of a body, which divides the human body into a left part and a right part. The coronal plane refers to a plane perpendicular to the ground made along a left-right direction of the body, which divides the human body into a front part and a rear part. The horizontal plane refers to a plane parallel to the ground made along an up-and-down direction of the body, which divides the human body into an upper part and a lower part. Correspondingly, the sagittal axis refers to an axis along the anteroposterior direction of the body and perpendicular to the coronal plane. The coronal axis refers to an axis along the left-right direction of the body and perpendicular to the sagittal plane. The vertical axis refers to an axis along the up-and-down direction of the body and perpendicular to the horizontal plane. Furthermore, “a front side of the ear” described in the present disclosure is a concept relative to “a rear side of the ear”. The former refers to a side of the ear away from the head, and the latter refers to a side of the ear facing the head, both are relative to the ear of the user. When the ear of the aforementioned simulator is observed along a direction of the coronal axis of the human body, a schematic diagram illustrating a front contour of the ear shown in FIG. 1 may be obtained.

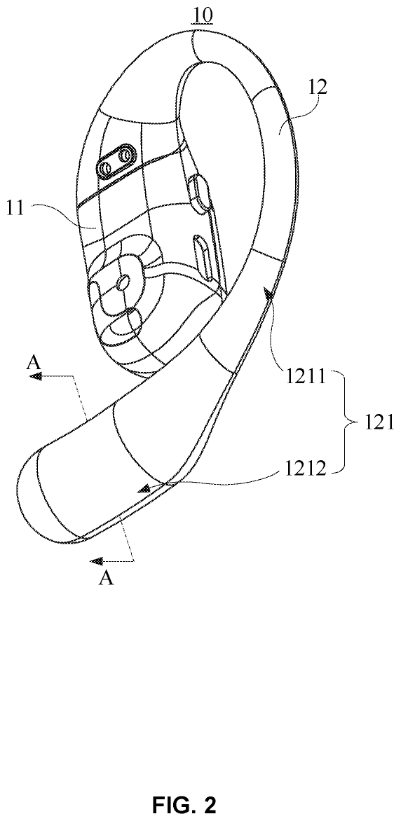

Merely by way of example, in conjunction with FIG. 2 to FIG. 4, the earphone 10 may include a core module 11 and an ear hook portion 12 connected to the core module 11. The core module 11 is located at a front side of an ear in a wearing state, and at least a portion of the ear hook portion 12 is hooked on a rear side of the ear in the wearing state, so that the earphone 10 is hooked on the ear in the wearing state. The core module 11 may include a connection end CE connected to the ear hook portion 12 and a free end FE not connected to the ear hook portion 12. Furthermore, the core module 11 may be configured to not block an external acoustic meatus in the wearing state, which enables the earphone 10 to function as an “open earphone”. Due to individual differences of different users, when the earphone 10 is worn by the different users, the core module 11 may partially cover the external acoustic meatus, but the external acoustic meatus remains unblocked.

Optionally, in some embodiments, the core module 11 includes a core housing (in some embodiments of the present disclosure, the core housing is also referred to as a housing assembly 110), a speaker 111, and a main control circuit board 112. The speaker 111 and the main control circuit board 112 are stacked in the core housing. Such a configuration can effectively improve the space utilization of the earphone 10. The speaker 111 is a component capable of converting an electrical signal into a corresponding sound signal under control of the main control circuit board 112. The main control circuit board 112 is an integrated circuit module of the earphone 10. A plurality of control circuits (e.g., main control circuits) for controlling components such as the speaker 111, Bluetooth, a microphone, etc., of the earphone 10 are disposed on the main control circuit board 112. In the embodiments, the speaker 111 is an air conduction speaker 111. In other embodiments, the speaker 111 may also be configured as a bone conduction speaker 111.

Optionally, in some embodiments, the housing assembly 110 includes a first housing 1101 and a second housing 1102 that cooperate with each other. Such a configuration can effectively improve assembly efficiency of the earphone 10.

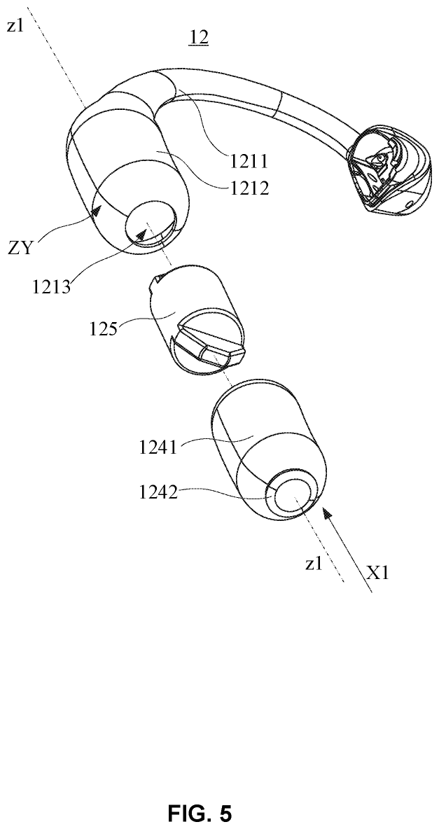

Optionally, as shown in FIG. 5 to FIG. 8, in some embodiments, the ear hook portion 12 includes an elastic connector 122 and an accommodating housing 124. One end of the elastic connector 122 is connected to the core module 11, and the other end is connected to the accommodating housing 124. With such a configuration, the elastic connector 122 can provide an elastic force to the core module 11 located at a front side of the ear and the accommodating housing 124 located at a rear side of the ear, so that the elastic connector 122 clamps the front side and the rear side of the ear through the accommodating housing 124 and the core module 11, thereby effectively improving wearing stability of the earphone 10.

Optionally, as shown in FIG. 5 to FIG. 8, in some embodiments, the ear hook portion 12 further includes an elastic coating body 121 coating peripheries of the elastic connector 122 and the accommodating housing 124. The elastic coating body 121 is a flexible member with elasticity. With such a configuration, the ear hook portion 12 abuts against an ear through the elastic coating body 121, thereby effectively improving the wearing comfort of the ear hook portion 12 and further effectively improving the wearing comfort of the earphone 10.

Optionally, as shown in FIG. 5 to FIG. 8, in some embodiments, the accommodating housing 124 forms an accommodating chamber 1243. The accommodating chamber 1243 is configured to accommodate at least a part (e.g., a battery) of internal structural components of the earphone 10. Furthermore, in some embodiments, the elastic coating body 121 includes a first coating section 1211 and a second coating section 1212. At least a portion of the second coating section 1212 is sleeved to coat at least a portion of a periphery of the accommodating housing 124 away from the elastic connector 122, to reduce a damage risk of the internal structural components if other assembly processes are adopted to assemble the portion of the second coating section 1212 to the portion of the periphery of the accommodating housing 124, which further improves working stability of the earphone 10 and also effectively reduces assembly complexity of the ear hook portion 12. Furthermore, in some embodiments, at least a portion of the first coating section 1211 is molded to coat a periphery of the elastic connector 122, which can effectively improve stability of the ear hook portion 12. For example, in some embodiments, at least a portion of the first coating section 1211 may be molded by injection molding to coat the periphery of the elastic connector 122.

Specifically, in this embodiment, the first coating section 1211 and the second coating section 1212 are an integrated structure, which can effectively reduce assembly complexity of the ear hook portion 12. In other embodiments, the first coating section 1211 and the second coating section 1212 may also be a split structure.

Optionally, as shown in FIG. 5, in some embodiments, the accommodating housing 124 includes a first housing 1241 and a second housing 123. One end of the second housing 123 is connected to the other end (i.e., a free end ZY of the elastic connector 122) of the elastic connector 122, and the other end of the second housing 123 is connected to the first housing 1241, to cooperate with the first housing 1241 to form the accommodating chamber 1243. The second coating section 1212 includes an opening 1213 at the free end ZY away from the elastic connector 122. Specifically, during assembly, the second coating section 1212 may be pushed up from an end of the second coating section 1212 where the opening 1213 is located, to enable a connection point between the first housing 1241 and the second housing 123 to be exposed, thereby enabling the first housing 1241 to be easily connected to the second housing 123. After the connection is completed, the second coating section 1212 is pushed down and sleeved on at least a portion of a periphery of the first housing 1241. With such a configuration, the second coating section 1212 can be sleeved to coat the periphery of the first housing 1241, thereby effectively improving working stability of the earphone 10 and also effectively reducing assembly complexity of the ear hook portion 12. It should be noted that in some embodiments, the second housing 123 may not be provided, and the elastic connector 122 is directly connected to the first housing 1241, that is, the connection point is provided at a free end of the elastic connector 122.

Preferably, in some embodiments, the accommodating housing 124 further includes a boss 1242 disposed at an end of a free end of the first housing 1241 away from the elastic connector 122. The opening 1213 of the second coating section 1212 is arranged around a periphery of a side circumferential wall of the boss 1242. With such a configuration, the opening 1213 can form a cooperation relationship with the boss 1242, thereby effectively improving connection stability between the elastic coating body 121 and the accommodating housing 124, and reducing the risk of relative movement between the elastic coating body 121 and the accommodating housing 124. Moreover, the elastic coating body 121 provided with the opening 1213 can completely coat the periphery of the accommodating housing 124 except for the boss 1242, which ensures that in the wearing state, positions of the accommodating housing 124 abutting with the head and the ear can abut against the head and the ear through the elastic coating body 121, thereby effectively improving the wearing comfort of the earphone 10. Specifically, in some embodiments, the boss 1242 and the first housing 1241 may be integrally arranged. In other embodiments, the boss 1242 and the first housing 1241 may be separately arranged. For example, in some embodiments, the boss 1242 and the first housing 1241 may be assembled by an assembly manner.

Optionally, as shown in FIGS. 5-8, in some embodiments, the second housing 123 serves as an adapter connecting the elastic connector 122 and the first housing 1241. One end of the second housing 123 is connected to the other end (i.e., an end of the elastic connector 122 away from the core module 11) of the elastic connector 122. A cross-sectional area of the second housing 123 gradually increases along a direction of the elastic connector 122 away from the core module 11 to form an arc-shaped transition, so as to improve the wearing comfort. Preferably, in some embodiments, the first coating section 1211 is further molded to coat a periphery of the second housing 123. Such a configuration can effectively simplify a coating process of the first coating section 1211 and facilitate the first coating section 1211 to be better attached to a transition area between the elastic connector 122 and the accommodating housing 124.

Optionally, in some embodiments, the second coating section 1212 is attached to an outer wall of the first housing 1241. Such a configuration can effectively improve connection stability between the second coating section 1212 and the first housing 1241. For example, in some embodiments, in a natural state (i.e., before the second coating section 1212 is sleeved on the first housing 1241), a radial size of a coating space formed by the second coating section 1212 is less than a radial size of the first housing 1241. With such a configuration, when the second coating section 1212 is sleeved on the first housing 1241, the first housing 1241 abuts against an inside of the second coating section 1212, so that the second coating section 1212 has a tendency to elastically contract toward the first housing 1241, thereby being attached to the outer wall of the first housing 1241, and thus effectively improving connection stability between the second coating section 1212 and the first housing 1241. Furthermore, in some embodiments, in a natural state (i.e., before the second coating section 1212 is sleeved on the first housing 1241), a radial size of the opening 1213 may also be set to be less than a radial size of the boss 1242. With such a configuration, when the second coating section 1212 is sleeved on the first housing 1241, an edge of the opening 1213 has a tendency to elastically contract toward the boss 1242, further improving connection stability between the second coating section 1212 and the first housing 1241.

Optionally, as shown in FIG. 7, in some embodiments, the edge of the opening 1213 is in contact with the side circumferential wall of the boss 1242, or a gap J1 between the edge of the opening 1213 and the side circumferential wall of the boss 1242 is less than 0.2 mm. Such a configuration can effectively prevent impurities such as dust and sweat from penetrating into (which may cause phenomena such as bulging of the ear hook portion 12) a gap between the second coating section 1212 and the accommodating housing 124 along the gap between the edge of the first housing 1241 and the side circumferential wall of the boss 1242. Moreover, when the radial size of the boss 1242 remains unchanged, the smaller the gap J1 is, the larger an area where a bottom of the second coating section 1212 along an axial direction z1 of the accommodating housing 124 abuts against the first housing 1241 is, which effectively reduces the risk of the second coating section 1212 detaching from the accommodating housing 124.

Further in conjunction with FIG. 7, the boss 1242 is a portion of the accommodating housing 124 that cooperates with the first housing 1241. The larger a radial size d1 of the boss 1242 is, the larger the radial size of the first housing 1241 after the second coating section 1212 is coated around the periphery of the accommodating housing 124 is. Such a configuration can result in a lack of a sufficiently large area at the bottom of the second coating section 1212 along the axial direction z1 of the accommodating housing 124 to abut against the first housing 1241, thereby increasing the risk of the second coating section 1212 detaching from the accommodating housing 124. Therefore, in some embodiments, the radial size d1 of the boss 1242 is less than a maximum radial size d2 of the first housing 1241. Such a configuration can effectively ensure that a bottom of the first housing 1241 (the bottom of the first housing 1241 is a bottom along the axial direction z1 of the first housing 1241 away from the second housing 123) is not completely occupied by the boss 1242. Thus, a sufficiently large area exists at the bottom of the first housing 1241 for abutting against the second coating section 1212, which effectively reduces the risk of the second coating section 1212 detaching from the accommodating housing 124.

Optionally, as shown in FIG. 7, in some embodiments, a ratio of the radial size d1 of the boss 1242 to the maximum radial size d2 of the first housing 1241 is between 0.4 and 0.7. Such a configuration can further ensure that a sufficiently large area exists at the bottom of the first housing 1241 for abutting against the second coating section 1212, thereby further reducing the risk of the second coating section 1212 detaching from the accommodating housing 124 while avoiding difficulties in assembly due to an overly small opening 1213.

Optionally, in some embodiments, when viewed in a direction X1 toward an outer end face of the boss 1242, the first housing 1241 and the boss 1242 are circular. Such a configuration makes a contour of the edge of the first housing 1241 and a contour of the side circumferential wall of the boss 1242 smoother, which reduces the risk of the second coating section 1212 tearing when being sleeved on the first housing 1241, thereby effectively enhancing the structural strength of the second coating section 1212. Moreover, configuring the boss 1242 as circular effectively improves the aesthetic appeal of the ear hook portion 12 while reducing the molding complexity of the accommodating housing 124 and the second coating section 1212.

It is worth noting that, in some embodiments, the direction X1 toward the outer end face of the boss 1242 is parallel to the axial direction z1 of the first housing 1241, and a coordination direction between the first housing 1241 and the second housing 123 is parallel to the axial direction z1 of the accommodating housing 124.

Optionally, in some implementations, when viewed in a direction toward an outer end of the boss 1242, the first housing 1241 is circular, that is, a contour of the first housing 1241 is circular (it should be noted that the term “circular” here may be understood as a similar circular structure such as an elliptical structure, a perfectly circular structure, etc.) along the axial direction z1 of the first housing 1241. For example, the first housing 1241 is an overall cylindrical structure. Such a configuration enables a side periphery of the first housing 1241 to be a smooth curved surface, thereby enabling the second coating section 1212 to abut against the head and the ear of the user with the smooth curved surface, thus effectively improving the wearing comfort of the earphone 10. Furthermore, a center of the first housing 1241 (i.e., a center of a circular contour of the first housing 1241 along the axial direction z1 of the first housing 1241) is concentric with a center of the boss 1242 (i.e., a center of a circular contour of the boss 1242 along the axial direction z1 of the first housing 1241), or a distance between the center of the first housing 1241 and the center of the boss 1242 is less than 5 mm. Since a relative position of the center of the first housing 1241 to the center of the boss 1242 directly affects a relative positional relationship between the first housing 1241 and the boss 1242, the first housing 1241 should be arranged as coaxially as possible with the boss 1242 to ensure that a resultant elastic force of elastic forces applied by the second coating section 1212 to the first housing 1241 is as parallel as possible to the axial direction z1 of the first housing 1241. Such a configuration prevents the resultant elastic force from affecting cooperation stability between the first housing 1241 and the second housing 123, and also effectively reduces the risk of the second coating section 1212 detaching from the first housing 1241. Therefore, configuring the center of the first housing 1241 to be concentric with the center of the boss 1242, or ensuring that the distance between the center of the first housing 1241 and the center of the boss 1242 is less than 5 mm, can effectively improve the connection stability between the first housing 1241 and the second housing 123 while effectively reducing the risk of the second coating section 1212 detaching from the first housing 1241.

Moreover, in some embodiments, in the wearing state, the axial direction z1 of the first housing 1241 is parallel to the sagittal plane, and the center of the boss 1242 is configured to be concentric with the center of the first housing 1241, which can effectively prevent the boss 1242 from contacting the head and the ear of the user, thereby effectively improving the wearing comfort of the earphone 10.

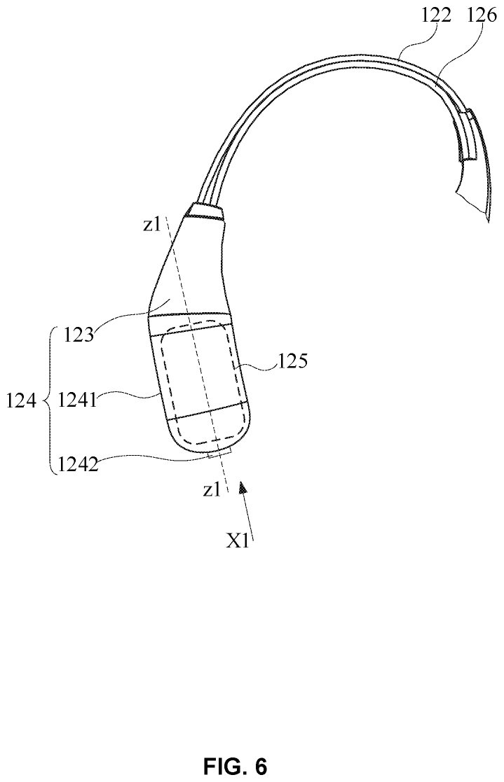

Optionally, as shown in FIG. 5 and FIG. 6, in some embodiments, the outer surface of the free end of the first housing 1241 is reduced in an arc-shaped transition in a direction (i.e., a positive direction along the axial direction z1 of the first housing 1241 and away from the second housing 123) away from the second housing 123. Such a configuration enables the outer surface of the bottom of the first housing 1241 to be arc-shaped, which effectively improves the wearing comfort and aesthetic appeal of the ear hook portion 12, without affecting the connection stability between the second coating section 1212 and the first housing 1241.

Optionally, as shown in FIG. 5 and FIG. 6, in some embodiments, the outer surface of the free end of the first housing 1241 is spherical. Such a configuration can effectively improve the aesthetic appeal and the wearing comfort of the ear hook portion 12.

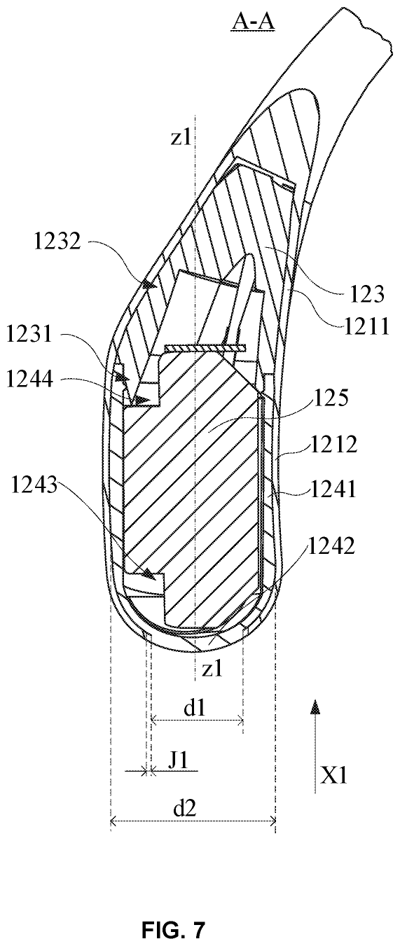

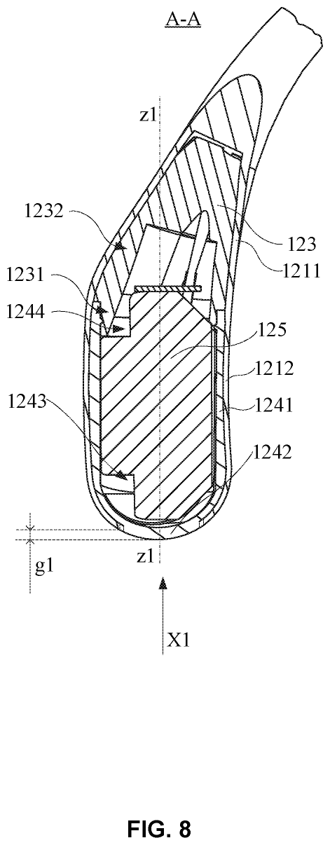

Optionally, as shown in FIG. 8, in some embodiments, at the boss 1242, an outer surface of the second coating section 1212 is flush with the outer end face of the boss 1242, or the outer end face of the boss 1242 protrudes from the outer surface of the second coating section 1212 by a protruding height not greater than 3 mm. Specifically, the boss 1242 is a portion of the accommodating housing 124 exposed from the second coating section 1212. Therefore, configuring the outer surface of the second coating section 1212 at the boss 1242 to be flush with the outer end face of the boss 1242, or configuring the outer end face of the boss 1242 to protrude from the outer surface of the second coating section 1212 by a protruding height g1 not greater than 3 mm, can effectively enhance the integrity of the ear hook portion 12 to improve the aesthetic appeal of the earphone 10, and can also effectively reduce the risk of the boss 1242 contacting the ear and head. In actual assembly processes, due to limited processing conditions or machining errors, it is difficult to achieve absolute flushness between the outer surface of the second coating section 1212 at the boss 1242 and the outer end face of the boss 1242. Therefore, in some embodiments, considering the aforementioned limitations, a height difference may exist between the outer surface of the second coating section 1212 and the outer end face of the boss 1242, and an absolute value of the height difference is within 0.01 mm. Such a configuration enables the outer surface of the second coating section 1212 and the outer end face of the boss 1242 to be nearly flush, thereby effectively improving the aesthetic appeal of the earphone 10.

As shown in FIG. 7 and FIG. 8, in some embodiments, the second housing 123 includes a main part 1232 and an inserting part 1231. The main part 1232 is connected to the elastic connector 122. The inserting part 1231 is connected to an end of the main part 1232 facing the accommodating housing 124. A radial size of the inserting part 1231 is less than a radial size of the main part 1232, thereby forming an annular step surface at a connection between the inserting part 1231 and the main part 1232. The accommodating housing 124 includes an open end 1244, the inserting part 1231 is inserted into the accommodating housing 124 from the open end 1244, and the open end 1244 further abuts against the annular step surface. At the open end 1244, an outer surface of the accommodating housing 124 and an outer surface of the main part 1232 transition smoothly. Such a configuration enables the outer surface of the elastic coating body 121 to present an overall smooth and continuous contour, effectively improving the wearing comfort of the earphone 10. The aforementioned manner can also effectively reduce the maximum radial size of the ear hook portion 12, thereby effectively reducing the overall structural size of the earphone 10.

Optionally, in some embodiments, the earphone 10 further includes glue at least filled between an outer surface of the first housing 1241 and the second coating section 1212. The glue is spaced apart from a circumferential side wall of the boss 1242. Such a configuration enables the first housing 1241 to be connected to the second coating section 1212 through the glue, effectively improving the connection stability between the first housing 1241 and the second coating section 1212, thereby effectively preventing the first housing 1241 from detaching from the second coating section 1212.

Optionally, in the embodiments, as shown in FIG. 7 and FIG. 8, the first housing 1241 serves as a main body of the accommodating housing 124 for forming the accommodating chamber 1243. The second housing 123 serves as an adapter connecting the first housing 1241 to the elastic connector 122, and also serves as a cover for the first housing 1241. Such a configuration, during assembly, enables components (e.g., a battery) placed in the accommodating chamber 1243 to be pre-placed in the first housing 1241, and then the first housing 1241 is connected to the second housing 123, thereby effectively improving the assembly efficiency of components (e.g., a battery).

Optionally, in some embodiments, the second housing 123 may serve as the main body of the accommodating housing 124, that is, the second housing 123 includes a connection main body (e.g., the main part 1232 in the above embodiments) connected to the elastic connector 122, and also includes an accommodating main body connected to the connection main body and configured to form the accommodating chamber 1243 with an opening at an end. Furthermore, the first housing 1241 serves as an end cover of the second housing 123 and covers an open end of the opening of the second housing 123 where the accommodating chamber 1243 is provided, to seal the accommodating chamber 1243. The open end of the second housing 123 is disposed at an end of the second housing 123 away from the elastic connector 122. Such a configuration enables an overall length of the first housing 1241 along the axial direction z1 less than an overall length of the second housing 123 along the axial direction z1, which effectively reduces the difficulty of the second coating section 1212 sleeved on the first housing 1241 during assembly, thereby effectively improving the assembly efficiency and convenience of the first housing 1241 and the second housing 123.

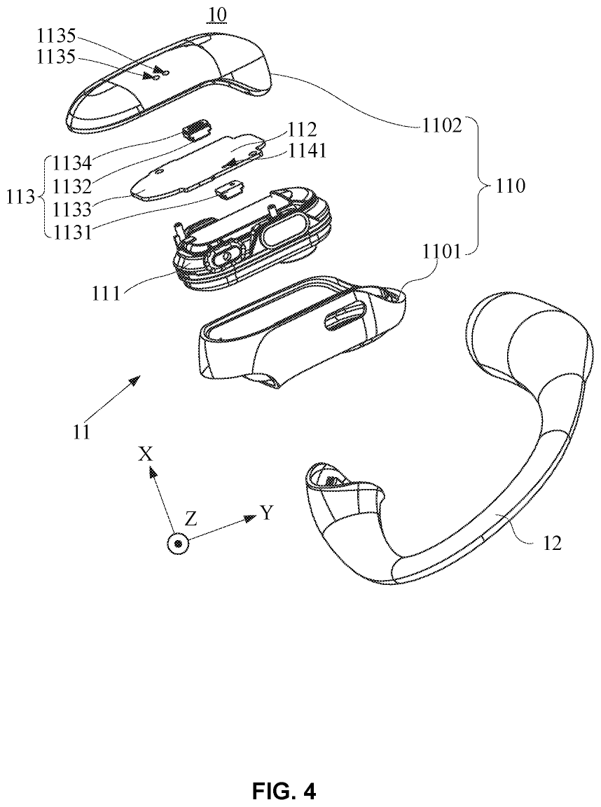

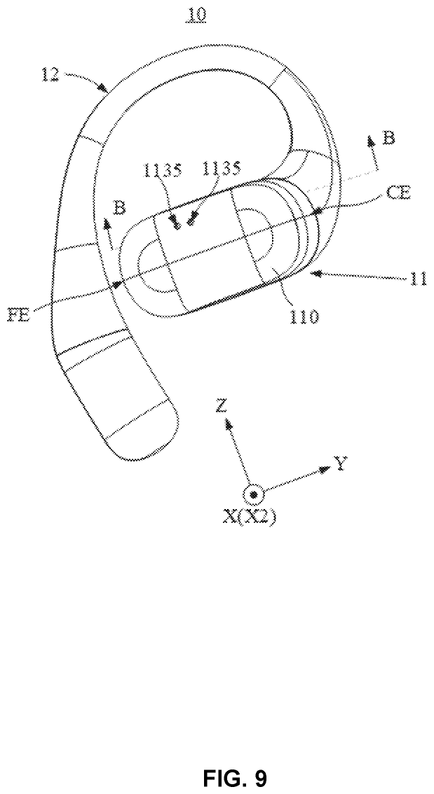

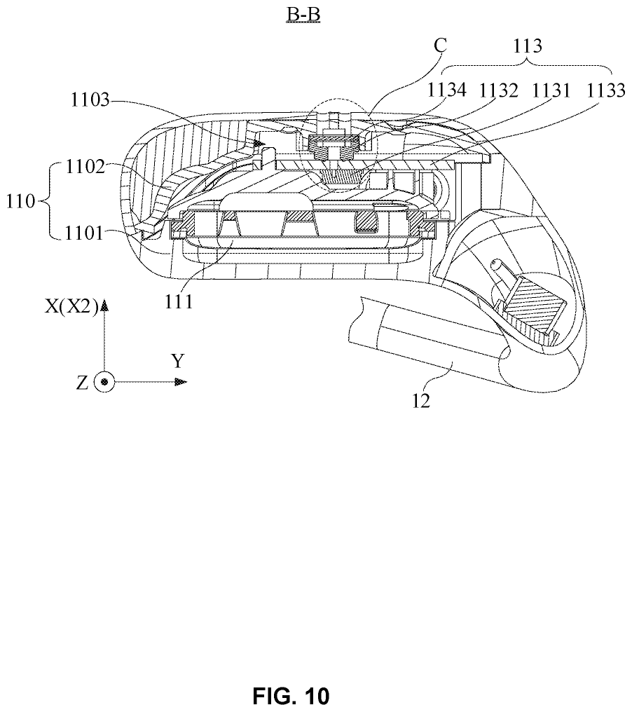

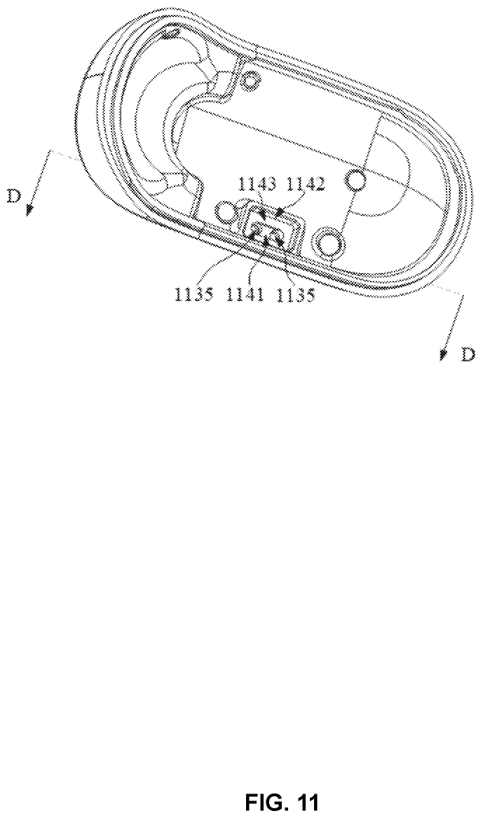

Optionally, as shown in FIG. 4, FIG. 9, FIG. 10, and FIG. 11, in some embodiments, the earphone 10 further includes a microphone assembly 113. The housing assembly 110 is configured to form an accommodating space 103. The microphone assembly 113 is disposed in the accommodating space 103. Two sound inlet holes 1135 that connect the accommodating space 103 with an exterior of the housing assembly 110 are provided on the housing assembly 110. Sound inlet ends of the two sound inlet holes 1135 are spaced apart from each other. A mounting groove 1142 is provided on an inner surface of the housing assembly 110, and sound outlet ends of the two sound inlet holes 1135 communicate with the mounting groove 1142. The microphone assembly 113 includes a sound guiding base 1132 and a microphone 1131. A sound guiding channel 1136 is provided on the sound guiding base 1132. The sound guiding base 1132 is embedded in the mounting groove 1142. A sound inlet end of the sound guiding channel 1136 communicates with the sound outlet ends of the two sound inlet holes 1135 within the mounting groove 1142. The microphone 1131 is configured to receive sound output from a sound outlet end of the sound guiding channel 1136.

Specifically, a sound inlet end of a sound inlet hole 1135 refers to an end (i.e., an end communicating with outside) where external sound enters the sound inlet hole 1135; a sound outlet end of the sound inlet hole 1135 refers to an end where the external sound enters the sound guiding channel 1136 after passing through the sound inlet hole 1135. The sound inlet end of the sound guiding channel 1136 refers to an end where the external sound enters the sound guiding channel 1136 after flowing out from the sound outlet end of the sound inlet hole 1135. Correspondingly, the sound outlet end of the sound guiding channel 1136 refers to an end where the external sound flows out from the sound guiding channel 1136 after passing through the sound guiding channel 1136. A path between the sound inlet end of the sound inlet hole 1135 and the sound outlet end of the sound guiding channel 1136 is referred to as a sound guiding path. Optionally, in some embodiments, the sound guiding channel 1136 may be configured as a straight-through type, a curved type, a multi-layer winding type, or other channel structure forms.

Preferably, in some embodiments, the housing assembly 110 is provided with two sound inlet holes 1135. The external sound may flow into the sound guiding channel 1136 through the two sound inlet holes 1135 and be transmitted to the microphone 1131, thereby effectively improving the sound pickup effect of the microphone 1131. Additionally, during sound pickup, a large airflow may enter the two sound inlet holes 1135. The airflow may enter the housing assembly 110 through one of the two sound inlet holes 1135 and flow out from the other one of the two sound inlet hole 1135, which can slow down the airflow speed and reduce the probability of the airflow impacting the microphone 1131 when passing through the sound guiding channel 1136 to reduce wind noise during sound pickup, thereby effectively improving the sound pickup effect of the microphone 1131.

Furthermore, in some embodiments, a sound inlet hole 1135 includes an extended channel that connects the sound inlet end of the sound inlet hole 1135 with the sound outlet end of the sound inlet hole 1135. In a wearing state, at least a portion of the extended channel near an exterior of the housing assembly 110 is inclined toward a rear side of a human body relative to a sagittal plane of the human body. An angle between an extension direction of the extended channel and the sagittal plane is greater than or equal to 5° and less than or equal to 40°. Such a configuration enables the extended channel of the sound inlet hole 1135 to extend at an angle toward the back of a human ear when the earphone is worn on the human body, thereby reducing the influence of the airflow and further improving the sound pickup effect.

Furthermore, in some embodiments, the mounting groove 1142 provided on the inner side of the housing assembly 110 can provide an effective positioning effect for the sound guiding base 1132 during installation, thereby effectively improving the installation accuracy and assembly efficiency of the sound guiding base 1132. Moreover, the mounting groove 1142 is a semi-enclosed area with a single-ended opening. After the sound guiding base 1132 is embedded in the area enclosed by the mounting groove 1142 along an opening of the mounting groove 1142, it is more conducive to forming a sealed connection between the mounting groove 1142 and the sound guiding base 1132, and forming a better enclosed area between the end of the sound guiding base 1132 where the sound inlet end of the sound guiding channel 1136 is located and the sound outlet ends of the two sound inlet holes 1135, thereby effectively improving the airtightness of the sound guiding path. Such a configuration can not only effectively prevent the airflow flowing out from the sound outlet ends of the two sound inlet holes 1135 from flowing through a gap between the sound guiding base 1132 and the mounting groove 1142 to generate noise, but also can effectively reduce the probability of frequency band loss of sound through a sound guiding path with high airtightness, thereby effectively improving the sound pickup effect of the microphone 1131.

Optionally, as shown in FIG. 10 to FIG. 13, in some embodiments, the microphone assembly 113 further includes a circuit board 1133. The circuit board 1133 is a board-like element provided with a processing circuit of the microphone 1131. Specifically, the sound guiding base 1132 is disposed on a side of the circuit board 1133 facing the mounting groove 1142. The microphone 1131 is disposed on the other side of the circuit board 1133 away from the mounting groove 1142. A communication hole 1141 is provided on the circuit board 1133. The microphone 1131 communicates with the sound outlet end of the sound guiding channel 1136 through the communication hole 1141. Such a configuration effectively shortens a spatial interval between the microphone 1131 and the processing circuit of the microphone 1131, thereby effectively reducing a wiring distance between the microphone 1131 and the processing circuit of the microphone 1131 and improving a space utilization inside the housing assembly 110. Furthermore, in some embodiments, the microphone 1131 may be directly disposed on the circuit board 1133. The microphone 1131 is connected to the processing circuit of the microphone 1131 through a wire on a board body of the circuit board 1133, thereby eliminating the need for additional circuit wire for wiring the microphone 1131, which further improves the space utilization inside the housing assembly 110 while effectively simplifying the overall structure of the earphone 10.

It should be noted that, in the present embodiments, the circuit board 1133 may be the main control circuit board 112 integrated with circuits such as a processing circuit of the microphone 1131, a main control circuit, etc. In other embodiments, the circuit board 1133 may only include the processing circuit of the microphone 1131, serving as an exclusive circuit component for the microphone 1131.

Furthermore, in some embodiments, the circuit board 1133 also serves as a pressing member for pressing and fixing the sound guiding base 1132 in the mounting groove 1142. Such a configuration effectively improves the connection stability between the sound guiding base 1132 and the mounting groove 1142. Moreover, the sound guiding base 1132, the circuit board 1133, and the microphone 1131 are stacked, which effectively improves the internal space utilization of the housing assembly 110. Specifically, a surface of the circuit board 1133 facing an inner wall abuts against a surface of the sound guiding base 1132 facing an interior of the earphone.

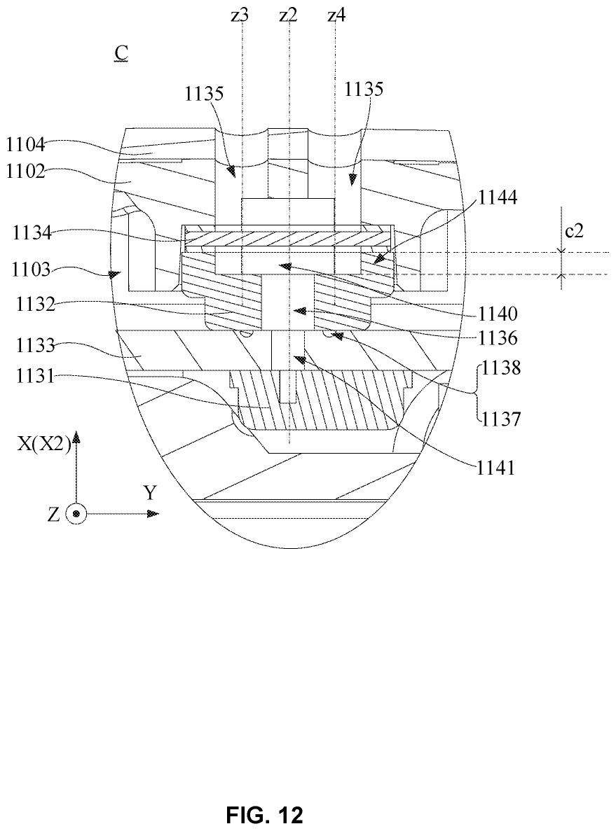

Optionally, as shown in FIG. 10 and FIG. 12, in some embodiments, the microphone assembly 113 further includes a sealing member 1137 disposed between the circuit board 1133 and the sound guiding base 1132. The sealing member 1137 is arranged around the sound outlet end of the sound guiding channel 1136 and the sound inlet end of the communication hole 1141. Such a configuration enables the sealing member 1137 to effectively seal an area between the circuit board 1133 and the sound guiding base 1132, to effectively seal an area between the sound outlet end of the sound guiding channel 1136 and the sound inlet end of the communication hole 1141, thereby further improving the sound pickup effect of the microphone 1131. The sealing member 1137 may be a rubber ring, glue, etc.

Preferably, as shown in FIG. 10 and FIG. 12, in some embodiments, an annular groove 1138 is provided on the circuit board 1133 or the sound guiding base 1132. The sealing member 1137 is disposed in the annular groove 1138. The sound outlet end of the sound guiding channel 1136 and the sound inlet end of the communication hole 1141 are located within an area enclosed by the annular groove 1138. The annular groove 1138 provides a good positioning effect for the sealing member 1137. During assembly, installing the sealing member 1137 through the annular groove 1138 can effectively improve the installation accuracy of the sealing member 1137, and effectively prevent the phenomenon of the sealing member 1137 blocking the sound outlet end of the sound guiding channel 1136 and the sound inlet end of the communication hole 1141 due to the installation error of the sealing member 1137. Moreover, the annular groove 1138 also has a good fixing effect, installing the sealing member 1137 in the annular groove 1138 can effectively improve the connection stability between the sealing member 1137 and the circuit board 1133 and/or the sound guiding base 1132, and prevent the sealing member 1137 from shifting laterally relative to the sound guiding base 1132 and the circuit board 1133 between the sound guiding base 1132 and the circuit board 1133 due to factors such as vibration, compression, etc., which may affect the sealing effect between the sound outlet end of the sound guiding channel and the sound inlet end of the communication hole 1141.

Optionally, in some embodiments, the sealing member 1137 is integrally formed with the sound guiding base 1132 and protrudes from the sound guiding base 1132. Such a configuration can effectively simplify the constituent structure of the earphone 10, thereby effectively improving the assembly efficiency of the earphone 10.

Optionally, in some embodiments, the sound guiding base 1132 may be made of rubber or other materials with a certain flexibility.

Optionally, as shown in FIG. 12, in some embodiments, the sound outlet ends of the two sound inlet holes 1135 and the sound inlet end of the sound guiding channel 1136 are oppositely spaced apart along a spacing direction X2 of the sound guiding base 1132 and the two sound inlet holes 1135, to form a relatively large spacing space between the sound inlet end of the sound guiding channel 1136 and the sound outlet ends of the two sound inlet holes 1135, thereby reducing the flow velocity of the airflow to a certain degree, thus effectively reducing wind noise during sound pickup, so as to effectively improve the sound pickup effect of the microphone 1131. Moreover, spacing the sound inlet end of the sound guiding channel 1136 from the sound outlet ends of the two sound inlet holes 1135 also effectively reduces the probability of the airflow directly flowing into the sound guiding channel 1136, thereby effectively reducing the probability of the airflow impacting the microphone 1131, and thus effectively improving the sound pickup effect of the microphone 1131.

It is worth noting that, in any embodiment of the earphone 10 herein, the spacing direction X2 between the sound guiding base 1132 and the two sound inlet holes 1135 is parallel to a thickness direction X of the housing assembly 110.

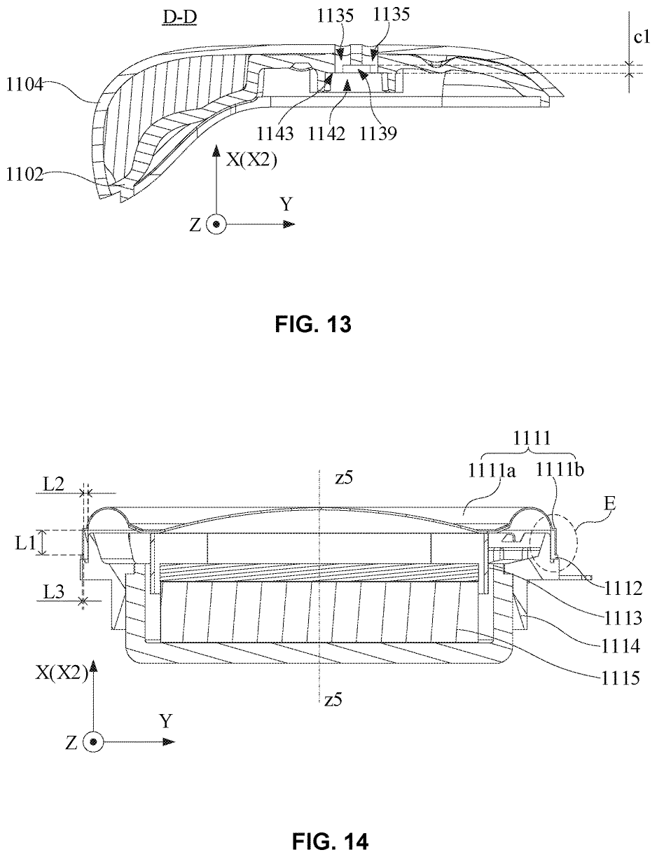

Preferably, as shown in FIG. 13, in some embodiments, sound outlet ends of the two sound inlet holes 1135 are located at a bottom of the mounting groove 1142. A first groove 1139 recessed in a direction away from the sound guiding base 1132 is provided at the bottom of the mounting groove 1142, and the sound outlet ends of the two sound inlet holes 1135 communicate with each other through the first groove 1139. Specifically, the first groove 1139 provides a communication channel for the two sound inlet holes 1135, so that the airflow flowing into from one of the two sound inlet holes 1135 may smoothly flow to the other of the two sound inlet holes 1135 along the first groove 1139, and then flow out of the earphone 10, thereby effectively reducing a flow velocity of the airflow and further effectively improving the sound pickup effect of the microphone 1131. Moreover, the first groove 1139 may also effectively increase a spacing distance and a size of a spacing space between the sound outlet ends of the two sound inlet holes 1135 and the sound inlet end of the sound guiding channel 1136, thereby effectively reducing the flow velocity of the airflow and further effectively improving the sound pickup effect of the microphone 1131.

Preferably, as shown in FIG. 13, in some embodiments, a depth c1 of the first groove 1139 is set as 0.25 to 0.55 mm. For example, the depth c1 may be 0.25 mm, 0.30 mm, 0.4 mm, 0.55 mm, or other actual values between 0.25 mm and 0.55 mm, so as to effectively ensure the space utilization of the housing assembly 110 while effectively improving the sound pickup effect of the microphone 1131. Specifically, if the depth c1 of the first groove 1139 is too deep, a thickness of the housing assembly 110 has to be increased to ensure a depth of the sound inlet hole 1135 for the sound guiding effect. Increasing the thickness of the housing assembly 110, under a condition that an overall structural size of the earphone 10 remains unchanged, inevitably reduces a size of an internal space of the housing assembly 110, which affects arrangement of other components of the earphone 10. Conversely, if the depth c1 of the first groove 1139 is too shallow, it is difficult to effectively guide the airflow from one of the sound inlet holes 1135 to the other sound inlet hole 1135, thereby affecting the sound pickup effect of the microphone 1131.

Optionally, as shown in FIG. 10 and FIG. 11, in some embodiments, the earphone 10 further includes an acoustic resistance mesh 1134. An annular step surface 1143 is reserved at the bottom of the mounting groove 1142 around the sound outlet ends of the two sound inlet holes 1135 and the first groove 1139. The sound guiding base 1132 presses and fixes the acoustic resistance mesh 1134 on the annular step surface 1143. The acoustic resistance mesh 1134 further covers the sound outlet ends of the two sound inlet holes 1135 and the first groove 1139.

Optionally, as shown in FIG. 12, in some embodiments, a second groove 1140 recessed in a direction away from the two sound inlet holes 1135 is provided on a side of the sound guiding base 1132 facing the two sound inlet holes 1135. The sound outlet ends of the two sound inlet holes 1135 communicate with each other through the second groove 1140, and the sound inlet end of the sound guiding channel 1136 is provided in the second groove 1140. Specifically, the second groove 1140 cooperates with the first groove 1139 to form a communication channel for the two sound inlet holes 1135. Such a configuration can effectively increase the spacing distance between the sound outlet ends of the two sound inlet holes 1135 and the sound inlet end of the sound guiding channel, thereby further reducing the flow velocity of the airflow, so as to further improve the sound pickup effect of the microphone 1131. Moreover, providing the second groove 1140 on the sound guiding base 1132 can effectively increase the spacing distance between the sound outlet ends of the two sound inlet holes 1135 and the sound inlet end of the sound guiding channel under a premise of effectively reducing an impact of the first groove 1139 on the space utilization (descriptions regarding how the depth c1 of the first groove 1139 affects the space utilization of the housing assembly 110 can be found in the previous descriptions, which is not repeated herein) of the housing assembly 110, thereby further reducing the flow velocity of the airflow and improving the sound pickup effect of the microphone 1131.

Preferably, in some embodiments, an annular flange 1144 is provided on the side of the sound guiding base 1132 facing the two sound inlet holes 1135. The annular flange 1144 encloses to form the second groove 1140. The annular flange 1144 is embedded in the mounting groove 1142. The annular flange 1144 presses and fixes the acoustic resistance mesh 1134 on the annular step surface 1143. The acoustic resistance mesh 1134 further covers the sound outlet ends of the two sound inlet holes 1135 and the first groove 1139.

Specifically, the acoustic resistance mesh 1134 is disposed between the sound outlet ends of the two sound inlet holes 1135 and the sound inlet end of the sound guiding channel 1136 in the above manner. Such a configuration can effectively reduce the flow velocity of the airflow entering through the two sound inlet holes 1135, thereby effectively reducing the probability of the airflow impacting the microphone 1131 through the sound guiding channel 1136, so as to reduce the wind noise during sound pickup, thereby effectively improving the sound pickup effect of the microphone 1131.

Optionally, in some embodiments, an extension direction of mesh holes of the acoustic resistance mesh 1134 is at least partially arranged to intersect the spacing direction X2. Such a configuration can effectively increase a blocking effect of the acoustic resistance mesh 1134 on the airflow, thereby effectively reducing the probability of the airflow impacting the microphone 1131 through the sound guiding channel 1136, so as to reduce wind noise during sound pickup, thereby effectively improving the sound pickup effect of the microphone 1131.

Optionally, in some embodiments, an acoustic resistance mesh includes at least a gauze mesh and a steel mesh stacked along the spacing direction X2. The steel mesh may be a three-dimensional woven mesh. An angle between an extension direction of mesh holes of the steel mesh and the spacing direction X2 is 45°, which can effectively improve a blocking effect of the steel mesh on the airflow.

Optionally, in some embodiments, the acoustic resistance mesh includes at least two steel mesh layers stacked along the spacing direction X2 to further improve the sound pickup effect.

Optionally, as shown in FIG. 12, in some embodiments, the sound guiding base 1132 is supported on the bottom of the mounting groove 1142. A projection of the first groove 1139 along the spacing direction X2 falls within the second groove 1140.

Preferably, in some embodiments, a depth c2 of the second groove 1140 is set as 0.2 to 0.5 mm. For example, the depth c2 may be 0.25 mm, 0.30 mm, 0.4 mm, 0.50 mm, or other actual values between 0.25 mm and 0.50 mm, so that a structural size of the sound guiding base 1132 is set more reasonably, to ensure the space utilization of the housing assembly 110 while effectively increasing the spacing distance between the sound outlet ends of the two sound inlet holes 1135 and the sound inlet end of the sound guiding channel, thereby effectively improving the sound pickup effect of the microphone 1131. Specifically, if the depth c2 of the second groove 1140 is too deep, a structural size of the sound guiding base 1132 may be increased, which affects the space utilization of the housing assembly 110. If the depth c2 of the second groove 1140 is too shallow, the spacing distance between the sound outlet ends of the two sound inlet holes 1135 and the sound inlet end of the sound guiding channel may be reduced.

Optionally, in some embodiments, a projection of the sound inlet end of the sound guiding channel 1136 along the spacing direction X2 at least partially falls within a spacing area between the two sound inlet holes 1135. With such a configuration, the projection of the sound inlet end of the sound guiding channel 1136 along the spacing direction X2 does not completely overlap a projection of the sound outlet end of any of the two sound inlet holes 1135, which effectively prevent the airflow from flowing out of the sound outlet end of one sound inlet hole 1135 and directly flowing into the sound guiding channel 1136, further effectively improving the sound pickup effect of the microphone 1131.

Optionally, in some embodiments, the sound inlet end of the sound guiding channel 1136 includes a center line z2 parallel to the spacing direction X2. The sound outlet ends of the two sound inlet holes 1135 include center lines (z3 and z4) parallel to the spacing direction X2. The center line z2 of the sound inlet end of the sound guiding channel 1136 is located between the center line z3 and the center line z4 of the sound outlet ends of the two sound inlet holes 1135. The center line z2 of the sound inlet end of the sound guiding channel 1136 and the center lines (z3 and z4) of the sound outlet ends of the two sound inlet holes 1135 are all located in a same vertical plane. Thus, the projection of the sound inlet end of the sound guiding channel 1136 along the spacing direction X2 includes a first projection portion overlapping the projection of the sound outlet end of one of the two sound inlet holes 1135, a second projection portion overlapping the projection of the sound outlet end of the other one of the two sound inlet holes 1135, and a third projection portion not overlapping the projections of the sound outlet ends of the two sound inlet holes 1135. An area of the first projection portion is equal to an area of the second projection portion. Such a configuration can effectively reduce a sound difference respectively introduced into the sound guiding channel 1136 through the two sound inlet holes 1135, thereby effectively improving the sound pickup effect of the microphone 1131.

Optionally, in some embodiments, the two sound inlet holes 1135 have a same structure, which can effectively reduce a sound difference respectively introduced through the two sound inlet holes 1135, thereby effectively improving the sound pickup effect of the microphone 1131.

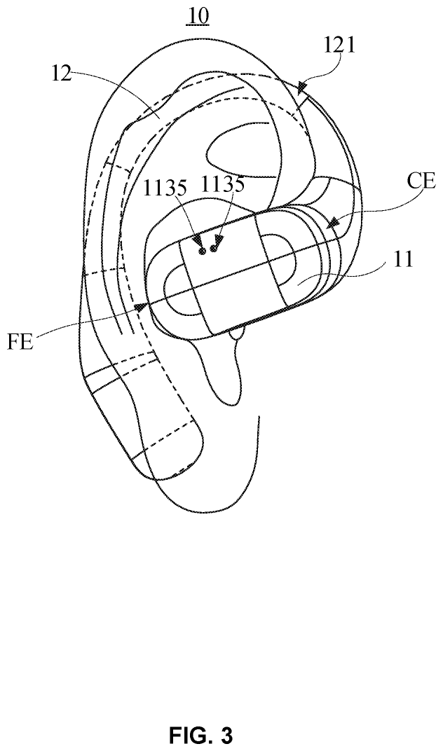

Optionally, as shown in FIG. 3 and FIG. 4, in some embodiments, the housing assembly 110 includes a first housing 1101 and a second housing 1102 assembled along a preset assembly direction. The preset assembly direction is parallel to the thickness direction X of the housing assembly 110. In a wearing state, along the preset assembly direction, the first housing 1101 is near an ear, and the second housing 1102 is away from the ear. The mounting groove 1142 and the two sound inlet holes 1135 are disposed on the second housing 1102, and the sound inlet ends of the two sound inlet holes 1135 are located on a side of the second housing 1102 away from the first housing 1101 along the thickness direction. Such a configuration can effectively prevent the sound inlet ends of the two sound inlet holes 1135 from being blocked by the ear or the head of the user, thereby effectively improving the sound pickup effect of the microphone 1131.

Optionally, as shown in FIG. 4, FIG. 12, and FIG. 13, the housing assembly 110 further includes a flexible covering layer 1104. The flexible covering layer 1104 at least covers an outer surface of a position of the second housing 1102 where the sound inlet holes 1135 are disposed. Two through holes corresponding to the two sound inlet holes 1135 are provided at positions of the flexible covering layer 1104 corresponding to the two sound inlet holes 1135. The two through holes respectively serve as extension portions 1155 of the sound inlet ends of the two sound inlet holes 1135, so that the two sound inlet holes 1135 communicate inside and outside of the housing assembly 110. Furthermore, providing the flexible covering layer 1104 on the outer surface of the position of the second housing 1102 where the sound inlet holes 1135 are disposed can enable the flexible covering layer 1104 to block noise from an external environment to a certain degree, thereby reducing noise flowing into the sound guiding channel 1136 and effectively improving the sound pickup effect of the microphone 1131.

Optionally, in some embodiments, the flexible covering layer 1104 completely covers the outer surface of the second housing 1102.

Optionally, as shown in FIG. 14, in some embodiments, the speaker 111 is an air conduction speaker 111. The speaker 111 includes a diaphragm 1111, a fixing ring 1112, and a frame 1114. The diaphragm 1111 includes a vibration body 1111a and an annular fixing portion 1111b connected to the vibration body 1111a and around a periphery of the vibration body 1111a. The fixing ring 1112 is fixedly connected to the annular fixing portion 1111b and sleeved on the frame 1114. A first connection length L1 exists between the annular fixing portion 1111b and the fixing ring 1112 along an axial direction z5 of the speaker 111. A second connection length L2 exists between the annular fixing portion 1111b and the fixing ring 1112 along a radial direction of the speaker 111. The first connection length L1 is greater than the second connection length L2.

Specifically, the diaphragm 1111 includes the vibration body 1111a and the annular fixing portion 1111b. The vibration body 1111a may move relative to the frame 1114 and the annular fixing portion 1111b along a preset vibration direction of the speaker 111 under an electromagnetic action to convert an electromagnetic signal into sound. The annular fixing portion 1111b is relatively fixed to the frame 1114 through the fixing ring 1112, that is, the fixing ring 1112 is sleeved on one end of the frame 1114 and fixedly connected to the frame 1114, and the annular fixing portion 1111b is fixedly connected to the fixing ring 1112. Such a configuration enables the diaphragm 1111 to be fixed on the frame 1114 through the fixing ring 1112. The frame 1114 is used to fix sound-producing components including the diaphragm 1111, a magnetic circuit assembly 1115, a voice coil 1113, etc., in the housing assembly 110. When the diaphragm 1111 is in vibration operation, a portion of vibration energy is transmitted to the frame 1114, and then to the housing assembly 110 and even the entire earphone 10, which enables the entire earphone 10 to generate noise that interferes with normal sound production of the speaker 111, thereby affecting a sound quality of the earphone 10. Therefore, the fixing ring 1112 is disposed between the frame 1114 and the diaphragm 1111, so that the diaphragm 1111 is fixedly connected to the frame 1114 through the fixing ring 1112, which can effectively reduce the vibration energy transmitted from the diaphragm 1111 to the frame 1114, thereby effectively reducing noise of the earphone 10 and effectively improving the sound quality of the earphone 10. Preferably, materials for producing the fixing ring 1112 may include a certain flexible material, so that the fixing ring 1112 has structural stiffness while also having a certain flexibility, which can further reduce the vibration energy transmitted from the diaphragm 1111 to the frame 1114, thereby effectively reducing noise of the earphone 10 and effectively improving the sound quality of the earphone 10. Preferably, a connection between the fixing ring 1112 and the annular fixing portion 1111b and/or a connection between the fixing ring 1112 and the frame 1114 may be fixedly connected by glue through a spot-dispensing manner, which can further reduce the vibration energy transmitted from the diaphragm 1111 to the frame 1114, thereby effectively reducing noise of the earphone 10 and effectively improving the sound quality of the earphone 10.

Specifically, in some embodiments, a manner for connecting the annular fixing portion 1111b to the fixing ring 1112 includes a lateral connection (i.e., setting the first connection length L1 between the annular fixing portion 1111b and the fixing ring 1112 as described above) and a radial connection (i.e., setting the second connection length L2 between the annular fixing portion 1111b and the fixing ring 1112 as described above). Preferably, in some embodiments, the manner for connecting the annular fixing portion 1111b to the fixing ring 1112 under which the lateral connection is the primary and the radial connection is auxiliary (i.e., the first connection length L1 is greater than the second connection length L2 as described above). The radial connection serves as the auxiliary connection between the annular fixing portion 1111b and the fixing ring 1112. Under a premise that the lateral connection is sufficient to maintain connection stability between the annular fixing portion 1111b and the fixing ring 1112, the radial connection may not be set between the annular fixing portion 1111b and the fixing ring 1112. In other words, the first connection length L1 may not be less than zero, while the second connection length L2 may be set as zero.

It should be noted that using the lateral connection as primary and the radial connection as auxiliary for connecting the annular fixing portion 1111b to the fixing ring 1112 can ensure connection stability between the annular fixing portion 1111b and the fixing ring 1112 while effectively reducing a radial size of the fixing ring 1112, thereby effectively reducing a radial size of the speaker 111 and further effectively reducing an overall volume of the speaker 111. Specifically, the diaphragm 1111 is a main component for generating sound through vibration. A radial size of the diaphragm, especially a radial size of the vibration body 1111a, directly affects sound quality of the speaker 111. Generally, a larger radial size of the vibration body is, a better sound quality of the speaker 111 may be. Therefore, the annular fixing portion 1111b and the fixing ring 1112 are mainly connected by the lateral connection, which can ensure that the vibration body of the diaphragm has a larger radial size (which can also be understood as that the speaker 111 is configured with the diaphragm 1111 having the vibration body 1111a with a larger radial size) under the premise of ensuring connection stability between the annular fixing portion 1111b and the fixing ring 1112, thereby effectively improving sound quality of the speaker 111 while effectively reducing the overall volume of the speaker 111.

Optionally, in some embodiments, a ratio of the first connection length L1 to the second connection length L2 is greater than 4, which can effectively improve the connection stability between the diaphragm 1111 and the fixing ring 1112 while effectively improving the sound quality of the speaker 111, and effectively reduce the overall volume of the speaker 111. Specifically, a smaller ratio of the first connection length L1 to the second connection length L2 requires the fixing ring 1112 with a larger radial size to connect to the diaphragm 1111. However, the larger radial size of the fixing ring 1112 increases the radial size of the speaker 111.

Optionally and preferably, in some embodiments, the first connection length L1 is not less than 0.5 mm. For example, the first connection length L1 may be 0.5 mm, 0.6 mm, 0.8 mm, 0.9 mm, or other actual values not less than 0.5 mm, to ensure connection stability between the fixing ring 1112 and the annular fixing portion 1111b. Specifically, the fixing ring 1112 and the annular fixing portion 1111b are mainly connected by the lateral connection. The first connection length L1 should not be too small. If the first connection length L1 is too small, the connection between the fixing ring 1112 and the annular fixing portion 1111b becomes unstable, which may affect the sound quality of the speaker 111. Preferably, in some embodiments, the first connection length L1 may be any value between 0.5 mm and 1.5 mm. For example, the first connection length L1 may be 0.5 mm, 0.6 mm, 0.8 mm, 0.9 mm, 1.5 mm, or other actual values between 0.5 mm and 1.5 mm.

Preferably, in some embodiments, the second connection length L2 is not greater than 0.2 mm. For example, the second connection length L2 may be 0 mm, 0.1 mm, 0.12 mm, 0.15 mm, or other actual values not greater than 0.2 mm, to reduce the radial size of the speaker 111. Specifically, the fixing ring 1112 and the annular fixing portion 1111b are mainly connected through the lateral connection. When a connection strength is sufficient, the second connection length L2 may be minimized as much as possible to control the radial size of the fixing ring 1112 to be smaller, further reducing the radial size of the speaker 111.

It should be noted that, when only the lateral connection exists between the annular fixing portion 1111b and the fixing ring 1112 (i.e., when the second connection length L2 is set as zero), there is no ratio between the first connection length L1 and the second connection length L2, or the ratio tends to infinity. In this case, a value of the first connection length L1 should be at least greater than a preset length threshold, and the preset length threshold is a minimum value that can ensure the connection stability between the annular fixing portion 1111b and the fixing ring 1112.

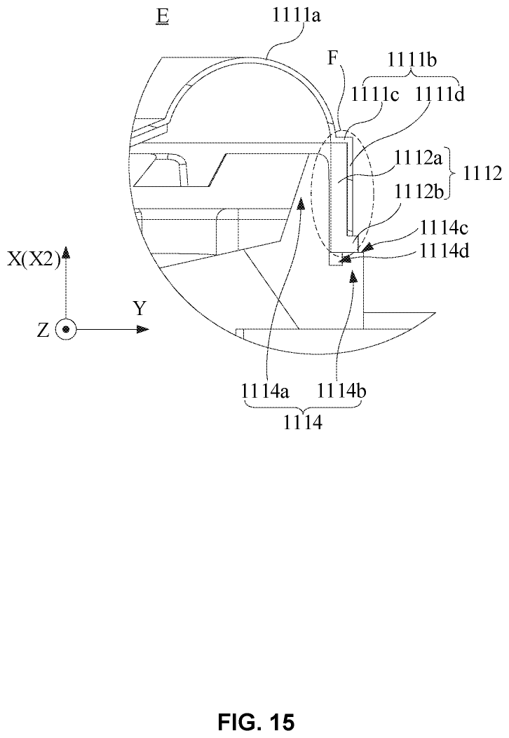

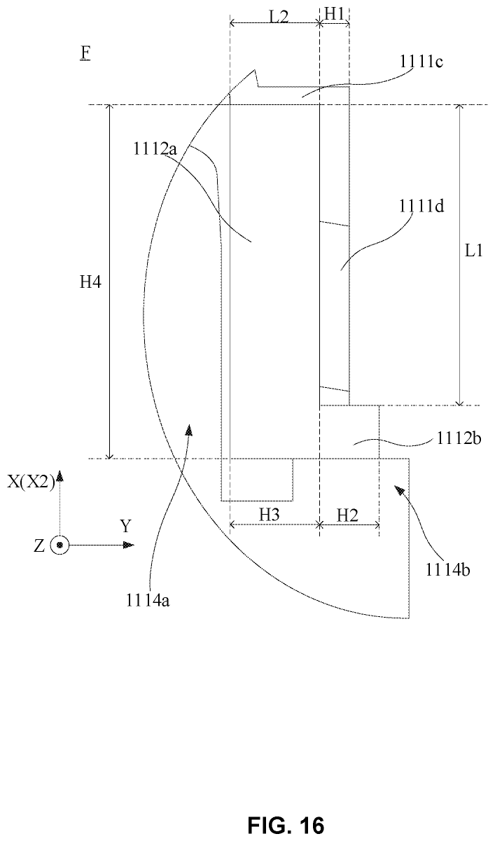

Optionally, as shown in FIG. 15 to FIG. 16, in some embodiments, the fixing ring 1112 includes a cylindrical body 1112a sleeved on the frame 1114. A height H4 of the cylindrical body 1112a along the axial direction z5 is greater than a wall thickness H3 of the cylindrical body 1112a along the radial direction. The annular fixing portion 1111b is fixedly connected to an inner circumferential surface or an outer circumferential surface of the cylindrical body 1112a to form the first connection length L1. The annular fixing portion 1111b is further fixedly connected to an end face (i.e., an end face of a side of the cylindrical body 1112a near the vibration body 1111a along the axial direction z5) of the cylindrical body 1112a to form the second connection length L2; or the annular fixing portion 1111b is only fixedly connected to the inner circumferential surface or the outer circumferential surface of the cylindrical body 1112a, such that the second connection length L2 is zero.

It should be noted that the cylindrical body 1112a may be understood as an overall structure of the cylindrical body 1112a being in a cylindrical shape. A contour of the cylindrical body 1112a along the axial direction z5 may be set based on a structural form of the diaphragm 1111. For example, an overall structural form of the diaphragm 1111 along the axial direction z5 may be racetrack-shaped, circular, square, etc. Correspondingly, the contour of the cylindrical body 1112a along the axial direction z5 may be set as racetrack-shaped, circular, square, etc., or other structural forms.

Specifically, in some embodiments, the annular fixing portion 1111b includes a first folded edge 1111c surrounding a peripheral side of the vibration body 1111a and connected to the vibration body 1111a, and a second folded edge 1111d connected to the first folded edge 1111c. The second folded edge 1111d is an annular folded edge extending along the axial direction z5 of the speaker 111. The second folded edge 1111d is fixedly connected to the outer circumferential surface or the inner circumferential surface of the cylindrical body 1112a to form the first connection length L1. The first folded edge 1111c is an annular folded edge extending along a radial direction of the speaker 111. The first folded edge 1111c is fixedly connected to an end face of the cylindrical body 1112a (i.e., an end face of a side of the cylindrical body 1112a near the vibration body 1111a along the axial direction z5) to form the second connection length L2. Such a configuration enables the annular fixing portion 1111b to be fixedly connected by the lateral connection as primary and the radial connection (i.e., the second connection length L2 is provided between the annular fixing portion 1111b and the cylindrical body 1112a) as auxiliary, which can effectively improve sound quality of the speaker 111 and also effectively reduce an overall volume of the speaker 111.

Optionally, as shown in FIG. 15 and FIG. 16, in some embodiments, the diaphragm 1111 is fixedly connected to the inner circumferential surface or the outer circumferential surface of the cylindrical body 1112a only through the second folded edge 1111d, that is, only the first connection length L1 is provided between the annular fixing portion 1111b and the fixing ring 1112, and the second connection length L2 is set as zero, which can improve the sound quality of the speaker 111 and further reduce the overall volume of the speaker 111.

Optionally, in some embodiments, the annular fixing portion 1111b may not include the first folded edge 1111c. An outer periphery of the vibration body 1111a directly extends toward the axial direction z5 of the speaker 111 to form the second folded edge 1111d. The second folded edge 1111d is fixedly connected to the outer circumferential surface or the inner circumferential surface of the cylindrical body 1112a to form the first connection length L1, which can further improve the sound quality of the speaker 111and reduce the overall volume of the speaker 111.

Optionally, in some embodiments, the outer circumferential surface of the cylindrical body 1112a is an outer side wall of the cylindrical body 1112a along the radial direction of the speaker 111. The inner circumferential surface of the cylindrical body 1112a may be an inner side wall of the cylindrical body 1112a along the radial direction of the speaker 111.

Optionally, in some embodiments, an end face of a side of the cylindrical body 1112a near the vibration body 1111a along the axial direction z5 is recessed along the axial direction z5 of the speaker 111 to form an annular groove. The inner circumferential surface of the cylindrical body 1112a is a wall of the annular groove. The second folded edge 1111d is inserted into the annular groove 1138 to connect with the groove wall of the annular groove, thereby forming the first connection length L1.

Optionally, as shown in FIG. 16, in some embodiments, a thickness H1 of the annular fixing portion 1111b along the radial direction is less than the first connection length L1. Specifically, the thickness of the annular fixing portion 1111b along the radial direction is a thickness of the second folded edge 1111d. If the thickness H1 of the annular fixing portion 1111b is too large, a radial size of the speaker 111 increases. If the thickness H1 of the annular fixing portion 1111b is too small, a structural strength of the annular fixing portion 1111b is affected, which may affect connection stability between the annular fixing portion 1111b and the fixing ring 1112. Therefore, setting the thickness H1 of the annular fixing portion 1111b to be less than the first connection length L1 can effectively reduce the radial size of the speaker 111, thereby reducing the volume of the speaker 111. Moreover, in some embodiments, the thickness H1 of the annular fixing portion 1111b should further be not less than a preset thickness threshold, and a ratio of the first connection length L1 to the thickness H1 is greater than or equal to 5 and less than or equal to 15. Such a configuration can effectively improve the connection stability between the annular fixing portion 1111b and the fixing ring 1112.

Optionally, as shown in FIG. 16, in some embodiments, a ratio of the height H4 of the cylindrical body 1112a to the wall thickness H3 of the cylindrical body 1112a is greater than 6.6, and a ratio of the first connection length L1 to the height H4 of the cylindrical body 1112a is greater than 0.4. Specifically, the ratio of the height H4 of the cylindrical body 1112a to the wall thickness H3 of the cylindrical body 1112a may directly affect connection stability between the cylindrical body 1112a and the annular fixing portion 1111b and the radial size of the speaker 111. Therefore, setting the ratio of the height H4 of the cylindrical body 1112a to the wall thickness H3 of the cylindrical body 1112a to be greater than 6.6 can effectively improve the connection stability between the cylindrical body 1112a and the annular fixing member while effectively reducing the overall volume of the speaker 111. Furthermore, the height H4 of the cylindrical body 1112a is designed based on the first connection length L1, which can effectively ensure that a sufficiently large first connection length L1 is formed after the cylindrical body 1112a is connected to the annular fixing portion 1111b, so as to effectively improve the connection stability between the cylindrical body 1112a and the annular fixing portion 1111b. Therefore, limiting the ratio of the first connection length L1 to the height H4 of the cylindrical body 1112a to be greater than 0.4 can ensure that a sufficiently large first connection length L1 is formed after the cylindrical body 1112a is connected to the annular fixing portion 1111b, so as to effectively improve the connection stability between the cylindrical body 1112a and the annular fixing portion 1111b.

Optionally, as shown in FIG. 15 and FIG. 16, in some embodiments, the fixing ring 1112 further includes an annular flange 1112b protruding along the radial direction from the outer circumferential surface of the cylindrical body 1112a. Specifically, the annular flange 1112b is disposed at an end of the cylindrical body 1112a near the frame 1114, which enables the annular flange 1112b to serve as a reinforcing structure for the cylindrical body 1112a, thereby effectively increasing the structural strength of the cylindrical body 1112a, especially a bending resistance strength of the cylindrical body 1112a, and thus effectively improving the connection stability between the cylindrical body 1112a and the annular fixing portion 1111b.

Optionally, as shown in FIG. 16, in some embodiments, a ratio of a protruding distance H2 of the annular flange 1112b relative to the outer circumferential surface of the cylindrical body 1112a to the wall thickness H3 of the cylindrical body 1112a is between 0.66 and 1.0. Specifically, if the ratio of the protruding distance H2 of the annular flange 1112b relative to the outer circumferential surface of the cylindrical body 1112a to the wall thickness H3 of the cylindrical body 1112a is too large, the radial size of the speaker 111 increases. If the ratio of the protruding distance H2 of the annular flange 1112b relative to the outer circumferential surface of the cylindrical body 1112a to the wall thickness H3 of the cylindrical body 1112a is too small, the structural strength of the cylindrical body 1112a decreases. Therefore, setting the ratio of the protruding distance of the annular flange 1112b relative to the outer circumferential surface of the cylindrical body 1112a to the wall thickness of the cylindrical body 1112a between 0.66 and 1.0 can effectively improve the structural strength of the cylindrical body 1112a, so as to effectively improve the connection stability between the cylindrical body 1112a and the annular fixing portion 1111b while effectively reducing the overall volume of the speaker 111.

Optionally, as shown in FIG. 14 and FIG. 16, in some embodiments, the annular fixing portion 1111b is fixedly connected to the outer circumferential surface of the cylindrical body 1112a, and the thickness H1 of the annular fixing portion 1111b along the radial direction is less than the protruding distance H2 of the annular flange 1112b relative to the outer circumferential surface of the cylindrical body 1112a. Specifically, as described above, the thickness H1 of the annular fixing portion 1111b along the radial direction is the thickness of the second folded edge 1111d. The thickness of the second folded edge 1111d is less than the protruding distance H2 of the annular flange 1112b relative to the outer circumferential surface of the cylindrical body 1112a. Accordingly, an end face of a side of the second folded edge 1111d near the annular flange 1112b is further connected to the annular flange 1112b along the axial direction z5 of the speaker 111, while the inner circumferential surface of the second folded edge 1111d is connected to the outer circumferential surface of the cylindrical body 1112a, to form a third connection length L3, which can further improve the connection stability between the annular fixing portion 1111b and the cylindrical body 1112a. The third connection length L3 is greater than zero. In some embodiments, the third connection length L3 is greater than or equal to the thickness H1 of the annular fixing portion 1111b along the radial direction and less than the protruding distance H2 of the annular flange 1112b relative to the outer circumferential surface of the cylindrical body 1112a, so as to ensure that the second folded edge 1111d has a sufficient connection area on the annular flange 1112b, so that a connection strength at this location is not weaker than connection strengths at other locations, while also being protected by the annular flange 1112b. Furthermore, in some embodiments, the third connection length L3 is equal to the thickness H1 of the annular fixing portion 1111b along the radial direction.

Optionally, as shown in FIG. 14 and FIG. 16, in some embodiments, as described above, the third connection length L3 exists between the annular flange 1112b and the annular fixing portion 1111b along the radial direction of the speaker 111, wherein the third connection length is equal to the thickness H1 of the annular fixing portion 1111b.

Optionally, in some embodiments, the frame 1114 includes an insertion portion 1114a and a supporting portion 1114b connected to each other along the axial direction. A size of the supporting portion 1114b along the axial direction is greater than a size of the insertion portion 1114a along the axial direction, thereby forming an annular step surface 1114c at a connection between the insertion portion 1114a and the supporting portion 1114b. The insertion portion 1114a is inserted into the cylindrical body 1112a. The annular flange 1112b is supported on the annular step surface 1114c. The frame 1114 forms the annular step surface 1114c by the above manner, and the annular flange 1112b is supported on the annular step surface 1114c. Such a configuration can effectively increase a connection area between the fixing ring 1112 and the frame 1114, thereby effectively improving connection stability between the fixing ring 1112 and the frame 1114. Moreover, since a vibration direction (i.e., a preset vibration direction) of the diaphragm 1111 is parallel to the axial direction z5, when the diaphragm 1111 vibrates, a risk of the fixing ring 1112 detaching from the frame 1114 along the axial direction z5 exists. Therefore, fixing the fixing ring 1112 on the annular step surface 1114c can provide a supporting force along the axial direction z5 for the fixing ring 1112, which can reduce the risk of the fixing ring 1112 detaching from the frame 1114 along the axial direction z5, thereby effectively improving the connection stability between the fixing ring 1112 and the frame 1114.

Optionally, in some embodiments, a glue groove 1114d is provided on the annular step surface 1114c, and the fixing ring 1112 covers the glue groove 1114d. When the fixing ring 1112 and the frame 1114 are assembled, a fixing glue may be added into the glue groove 1114d to reinforce the connection stability between the frame 1114 and the fixing ring 1112.

Optionally, in some embodiments, along the radial direction (the radial direction of the speaker 111), the glue groove is disposed near a peripheral side of the insertion portion 1114a, so that the glue groove 1114d is away from a peripheral side of the supporting portion 1114b. When the frame 1114 and the fixing ring 1112 are fixedly connected by the fixing glue, the risk of the fixing glue overflowing to the peripheral side of the supporting portion 1114b can be decreased.

Optionally, as described above, the speaker 111 further includes the magnetic circuit assembly 1115 and the voice coil 1113. The magnetic circuit assembly 1115 is configured to form a magnetic gap. The frame 1114 surrounds a periphery of the magnetic circuit assembly 1115 and is relatively fixed to the magnetic circuit assembly 1115. One end of the voice coil 1113 is fixedly connected to the vibration body 1111a, and the other end of the voice coil 1113 extends into the magnetic gap and is coupled to the magnetic circuit assembly 1115 under an action of an electrical signal, so as to drive the vibration body 1111a to reciprocally vibrate along the axial direction z5, thereby generating sound.

Optionally, in some embodiments, the axial direction z5 of the speaker 111 in any of the above embodiments is arranged parallel to the thickness direction X of the housing assembly 110.

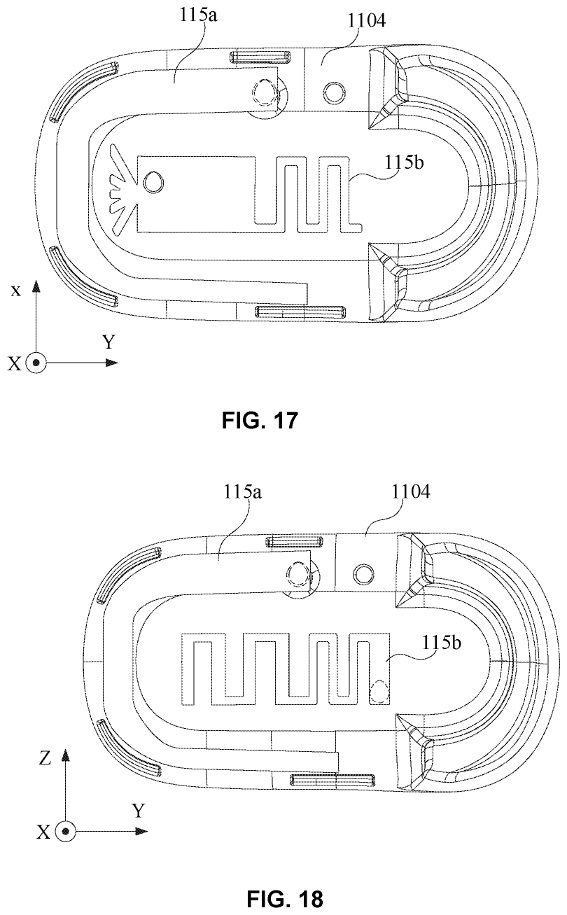

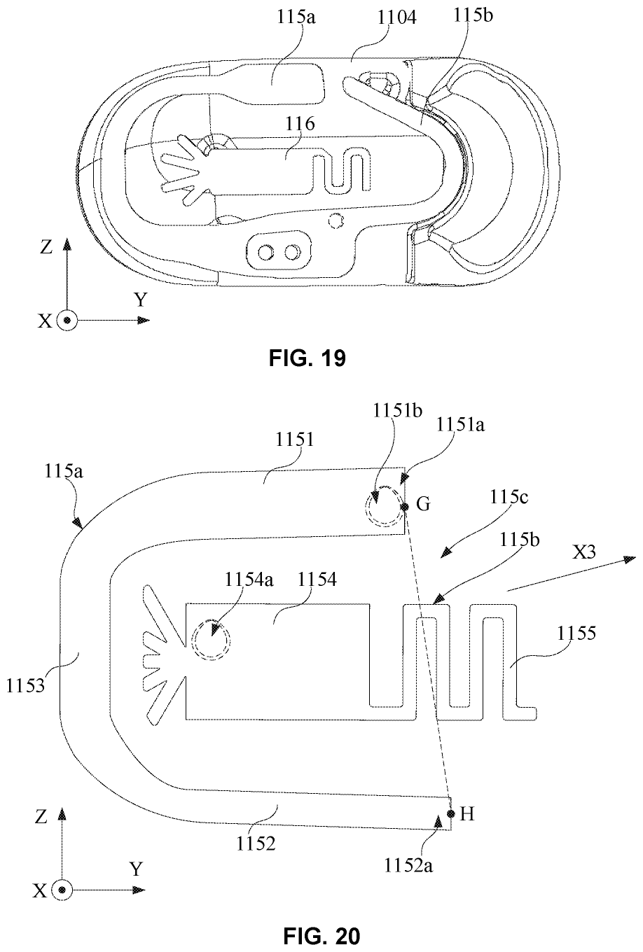

Optionally, as shown in FIG. 17 to FIG. 22, in some embodiments, the earphone 10 includes an antenna pattern 115. The antenna pattern 115 includes a first antenna pattern 115a and a second antenna pattern 115b. The first antenna pattern 115a is a component of the earphone 10 for receiving and/or transmitting a Bluetooth signal. A feed point 1151b for receiving a feed signal is provided on the first antenna pattern 115a. When the feed signal (i.e., an alternating electrical signal) is output by the feed point 1151b on the first antenna pattern 115a, a changing current is formed on the first antenna pattern 115a. Furthermore, the second antenna pattern 115b may be coupled to the first antenna pattern 115a to disperse the current on the first antenna pattern 115a, to prevent the current generated based on the feed signal from being completely concentrated on the first antenna pattern 115a, thereby effectively reducing a SAR value of the antenna pattern 115.

Specifically, a main surface of the first antenna pattern 115a is an extension plane of the first antenna pattern 115a. In some embodiments, the main surface of the first antenna pattern 115a is arranged perpendicular to the thickness direction X of the housing assembly 110. In some embodiments, the first antenna pattern 115a includes a starting end 1151a (the starting end 1151a includes an endpoint G) and a free end 1152a (the free end 1152a includes an endpoint H). The first antenna pattern 115a extends from the endpoint G of the starting end 1151a toward the endpoint H of the free end 1152a, thereby forming an extension direction. In different embodiments, the extension direction may be a straight line or a curved line.

Optionally, in some embodiments, the first antenna pattern 115a may be bent along its extension direction to form a first semi-enclosed structure with a first opening 115c. That is, an overall structure of the first antenna pattern 115a presents a curved semi-enclosed structure, which can ensure that a length of the first antenna pattern 115a can satisfy requirements for transmitting and/or receiving the Bluetooth signal, while also effectively improving the space utilization of the first antenna pattern 115a, thereby effectively reducing an overall structural size of the earphone 10.

Specifically, an opening direction of the first antenna pattern 115a is defined as follow: when viewed along a direction toward the main surface of the first antenna pattern 115a, a line segment GH is formed by connecting the endpoint G of the starting end 1151a and the endpoint H of the free end 1152a. A direction perpendicular to the line segment GH and pointing outward from the first semi-enclosed structure is a first opening direction X3.

Furthermore, in some embodiments, when viewed along the direction toward the main surface of the first antenna pattern 115a, a projection of the second antenna pattern 115b in a direction opposite to the opening direction (i.e., the first opening direction X3) of the first antenna pattern 115a at least partially overlaps with the first antenna pattern 115a. Such a configuration enables the second antenna pattern 115b to be at least partially located inside the first semi-enclosed structure formed by the first antenna pattern 115a or located on a side of the first semi-enclosed structure along the first opening direction X3, which can effectively improve overall the space utilization of the antenna pattern 115, enabling the antenna pattern 115 to be arranged on the earphone 10 with a smaller spatial structure size.

Furthermore, as shown in FIG. 20 to FIG. 22, in some embodiments, an arc-to-chord ratio of the first antenna pattern 115a is not less than 2. Specifically, the arc-to-chord ratio of the first antenna pattern 115a is a ratio of an extension length of the first antenna pattern 115a to the line segment GH connecting two endpoints (the endpoint G and the endpoint H) of the first antenna pattern 115a. Setting the arc-to-chord ratio of the first antenna pattern 115a to be not less than 2 (e.g., the arc-to-chord ratio may be 2, 2.5, 3, etc. ,) can effectively increase a bending degree of the first antenna pattern 115a, thereby effectively improving the space utilization of the first antenna pattern 115a. The extension length of the first antenna pattern 115a is a length of an arc GH between the endpoint G of the starting end 1151a and the endpoint H along the extension direction of the free end 1152a.

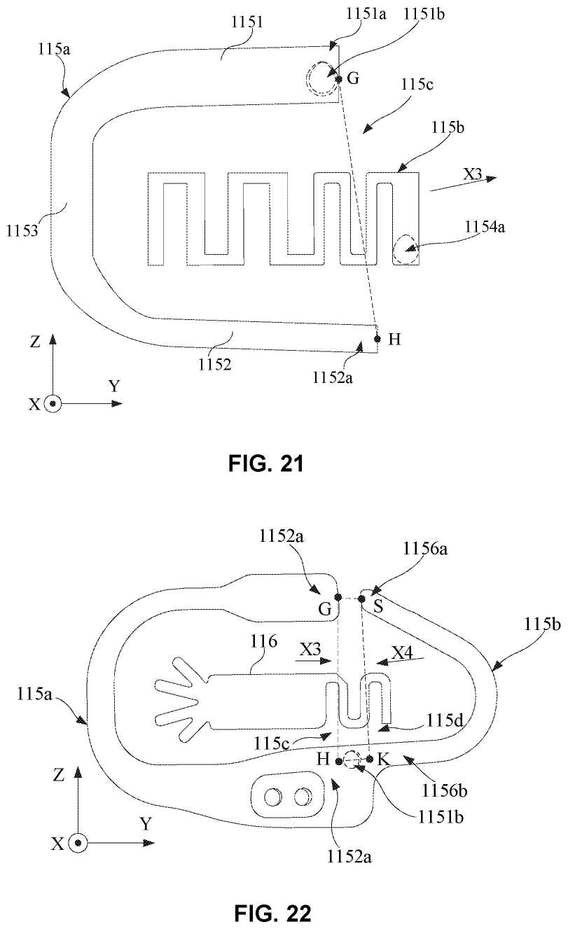

Optionally, as shown in FIG. 20 and FIG. 21, in some embodiments, the first antenna pattern 115a and the second antenna pattern 115b are spaced apart, and a grounding point 1154a for grounding is provided on the second antenna pattern 115b to serve as a parasitic branch of the first antenna pattern 115a. Specifically, the second antenna pattern 115b is connected to the first antenna pattern 115a only through coupling. The feed point 1151b is provided on the first antenna pattern 115a and near one endpoint of the first antenna pattern 115a (e.g., in some embodiments, the feed point 1151b is provided at the endpoint G of the starting end 1151a of the first antenna pattern 115a). The feed signal is directly transmitted to the first antenna pattern 115a through the feed point 1151b. Due to the coupling between the first antenna pattern 115a and the second antenna pattern 115b, the feed signal originally acting entirely on the first antenna pattern 115a can be dispersed to the first antenna pattern 115a and the second antenna pattern 115b through electromagnetic coupling. In other words, after the first antenna pattern 115a and the second antenna pattern 115b are coupled, the current flowing through the antenna pattern 115 is divided into two parts due to excitation of the feed signal. One part of the current acts on the first antenna pattern 115a, and the other part of the current acts on the second antenna pattern 115b, which prevents the current generated based on the feed signal from being completely concentrated on the first antenna pattern 115a or the second antenna pattern 115b, thereby dispersing the energy hotspots on the antenna pattern 115 and effectively reducing the SAR value of the antenna pattern 115. Preferably, in some embodiments, the grounding point 1154a is disposed as far away from the feed point 1151b as possible, which can further disperse the current, thereby further dispersing the energy hotspots on the antenna pattern 115 and reducing the SAR value of the antenna pattern 115.

Preferably, as shown in FIG. 20 and FIG. 21, in some embodiments, when the second antenna pattern 115b serves as the parasitic branch of the first antenna pattern 115a, a length (i.e., an arc length of the arc GH along an extension direction of the first antenna pattern 115a) of the first antenna pattern 115a and a length (i.e., an extension length of the second antenna pattern 115b) of the second antenna pattern 115b may be set to be the same, and the length of the first antenna pattern 115a is equal to one quarter of a wavelength of the feed signal. Such a configuration enables an overall length of the antenna pattern 115 to be half of the wavelength of the feed signal, thereby effectively improving the antenna function stability of the antenna pattern 115.

Optionally, as shown in FIG. 20 and FIG. 21, in some embodiments, at least a portion of the second antenna pattern 115b is arranged in a wavy shape, which can effectively extend the length of the second antenna pattern 115b within a limited space while also effectively improving the space utilization of the second antenna pattern 115b. As another example, as shown in FIG. 21, in some embodiments, the second antenna pattern 115b may also be arranged in a shape of a plurality of bent and connected “π” shapes.

Optionally, as shown in FIG. 20 and FIG. 21, in some embodiments, at least a portion of the second antenna pattern 115b is arranged in the first semi-enclosed structure. Such a configuration enables the second antenna pattern 115b to effectively utilize the area enclosed by the first semi-enclosed structure, thereby making the second antenna pattern 115b and the first antenna pattern 115a more compact and effectively improving the space utilization of the antenna pattern 115.

Preferably, in some embodiments, the first antenna pattern 115a includes a first pattern portion 1151 and a second pattern portion 1152 arranged side by side and a third pattern portion 1153 connecting the first pattern portion 1151 and the second pattern portion 1152, which enables the first pattern portion 1151, the second pattern portion 1152, and the third pattern portion 1153 to enclose to form the first semi-enclosed structure. In the present embodiments, the first semi-enclosed structure is arranged in a “U” shape. In some embodiments, the first semi-enclosed structure may be in a “C” shape, a “V” shape, or other semi-enclosed curved structures. Furthermore, in some embodiments, at least a portion of the second antenna pattern 115b is arranged between the first pattern portion 1151 and the second pattern portion 1152, and a projection of the second antenna pattern 115b in a direction opposite to an opening direction of the first antenna pattern 115a at least partially overlaps with the third pattern portion 1153. In other words, a portion of the second antenna pattern 115b is inserted into an interior of the first semi-enclosed structure, and the other portion of the second antenna pattern 115b extends out from an opening (i.e., the first opening 115c) of the first semi-enclosed structure and extends outwards, which enables the second antenna pattern 115b and the first antenna pattern 115a to be more compact, effectively improving the space utilization of the antenna pattern 115.

Optionally, as shown in FIG. 20, in some embodiments, at least a portion of the second antenna pattern 115b may be reused to detect a touch signal, which can effectively simplify the structure of the earphone 10, thereby effectively improving the assembly efficiency of the earphone 10. Preferably, in some embodiments, the second antenna pattern 115b includes a main portion 1154 arranged in a block shape and an extension portion 1155 connected to the main portion 1154 and arrange in a wavy shape. Specifically, the main portion 1154 is reused as a touch pattern 116 of the earphone 10 to receive the touch signal. Meanwhile, the extension portion 1155 extends a length of the main portion 1154 to cooperate with the main portion 1154 to enable the second antenna pattern 115b to form an antenna pattern with sufficient length, so as to disperse the current of the first antenna pattern 115a. Furthermore, in some embodiments, the extension portion 1155 may further be reused as a component for receiving the touch signal and effectively extending a touch area of the main portion 1154, thereby effectively improving the touch comfort of the earphone 10. In some embodiments, the extension portion 1155 may also be an inductor.

Preferably, in some embodiments, the earphone 10 is further provided with a grounding circuit including at least a capacitor. A first signal terminal of the capacitor is connected to the grounding point 1154a, and a second signal terminal of the capacitor is grounded. Such a configuration effectively prevents mutual interference between the touch signal and a Bluetooth signal when the at least a portion of the second antenna pattern 115b is reused to detect the touch signal.

Optionally, as shown in FIG. 22, in some embodiments, the second antenna pattern 115b is connected to the first antenna pattern 115a with the feed point 1151b as a boundary point, and the feed point 1151b is configured to respectively provide the feed signal to the first antenna pattern 115a and the second antenna pattern 115b. Such a configuration enables the feed signal emitted from the feed point 1151b to be divided into two parts, which flow to the first antenna pattern 115a and the second antenna pattern 115b, respectively. The current is effectively dispersed to the first antenna pattern 115a and the second antenna pattern 115b, respectively, to effectively reduce the current intensity loaded on the first antenna pattern 115a and the second antenna pattern 115b, thereby effectively reducing the SAR value of the antenna pattern 115. Meanwhile, the first antenna pattern 115a and the second antenna pattern 115b are coupled. Furthermore, a resultant current formed by the feed signal on the first antenna pattern 115a and a resultant current formed by the feed signal on the second antenna pattern 115b have a mutually suppressive relationship. Accordingly, a magnetic field formed based on the resultant current on the first antenna pattern 115a and a magnetic field formed based on the resultant current on the second antenna pattern 115b weaken each other, so as to effectively reduce a magnetic field strength of a resultant magnetic field of the antenna pattern 115 (i.e., a magnetic field formed by superimposing the magnetic field formed based on the resultant current on the first antenna pattern 115a and the magnetic field formed based on the resultant current on the second antenna pattern 115b), further reducing a proportion of a normal component of the resultant magnetic field entering the head of the user, thereby reducing an absorption rate of the resultant magnetic field by the human body and effectively reducing the SAR value of the antenna pattern 115.

Optionally, as shown in FIG. 22, in some embodiments, the second antenna pattern 115b is bent along an extension direction thereof (wherein the extension direction of the second antenna pattern 115b is defined in conjunction with the extension direction of the first antenna pattern 115a) to form a second semi-enclosed structure including a second opening 115d, which enables the second antenna pattern 115b to be arranged in an overall curved shape. Such a configuration, on one hand, can effectively improve the space utilization of the second antenna pattern 115b, on the other hand, can also enable the current flow on the second antenna pattern 115b to be in overall arc-shape, to correspond to the arc-shaped current flow on the first antenna pattern 115a (it has been described above that the first antenna pattern 115a is bent along the extension direction thereof), which is more conducive to forming electromagnetic fields with a mutually suppressive relationship. Furthermore, in some embodiments, a projection of the first antenna pattern 115a in a direction opposite to an opening direction (i.e., a second opening direction X4) of the second antenna pattern 115b at least partially overlaps with the second antenna pattern 115b. Such a configuration enables the first antenna pattern 115a and the second antenna pattern 115b to have overlapping portions along the first opening direction X3 or the second opening direction X4, that is, the first antenna pattern 115a and the second antenna pattern have portions arranged relatively along the first opening direction X3 or the second opening direction X4. Furthermore, since the currents on the first antenna pattern 115a and the second antenna pattern 115b flow into or out of the feed point 1151b simultaneously, the electromagnetic fields formed at least by the portions of the first antenna pattern 115a and the second antenna pattern 115b arranged relatively along the first opening direction X3 or the second opening direction X4 have a mutually suppressive relationship. Such a configuration can reduce the magnetic field strength of the resultant magnetic field of the antenna pattern 115, reduce the proportion of the normal component of the resultant magnetic field entering the head of the user, and reduce the absorption rate of the resultant magnetic field by the human body, thereby effectively reducing the SAR value of the antenna pattern 115.

Specifically, as shown in FIG. 22, the second antenna pattern 115b includes a starting end 1156b (the starting end 1156b includes an endpoint K) and a free end 1156a (the free end 1156a includes an endpoint S). The second antenna pattern 115b extends from the endpoint K of the starting end 1156b to the endpoint S of the free end 1156a, thereby forming the extension direction of the second antenna pattern 115b. Specifically, the second opening direction X4 is defined as follows: when viewed in a direction toward a main surface of the second antenna pattern 115b, a line segment KS is formed by connecting the endpoint K of the starting end 1156b of the second antenna pattern 115b and the endpoint S of the free end 1156a, and a direction perpendicular to the line segment KS and pointing outward from the second semi-enclosed structure is the second opening direction X4.

Optionally, as shown in FIG. 22, in some embodiments, in an area near the feed point 1151b, the first antenna pattern 115a and the second antenna pattern 115b extend away from each other starting from the feed point 1151b. Such a configuration enables the first antenna pattern 115a and the second antenna pattern 115b to be arranged relatively in the area near the feed point 1151b, which further enables the electromagnetic field formed on the first antenna pattern 115a and the electromagnetic field formed on the second antenna pattern 115b in the area near the feed point 1151b to have a mutually suppressive relationship, which reduces the magnetic field strength of the resultant magnetic field of the antenna pattern 115, reduces the proportion of the normal component of the resultant magnetic field entering the head of the user, and reduce the absorption rate of the resultant magnetic field by the human body, thereby effectively reducing the SAR value of the antenna pattern 115.

Optionally, as shown in FIG. 22, in some embodiments, the free end 1152a of the first antenna pattern 115a and the free end 1156a of the second antenna pattern 115b are arranged adjacent to each other. In an area near the free end 1152a of the first antenna pattern 115a and the free end 1156a of the second antenna pattern 115b, the first antenna pattern 115a and the second antenna pattern 115b extend toward each other with their respective free ends as terminal points. Such a configuration enables the second opening 115d of the second antenna pattern 115b and the first opening 115c of the first antenna pattern 115a to be arranged relatively, and enables a resultant electromagnetic field (wherein a magnetic field and an electric field are collectively referred to as the electromagnetic field) formed on the first antenna pattern 115a and a resultant electromagnetic field formed on the second antenna pattern 115b to be arranged different from each other, which reduces the proportion of the normal component of the resultant magnetic field finally formed in the area near the antenna pattern 115 entering the head of the user, and reduces the absorption rate of the resultant magnetic field by the human body, thereby effectively reducing the SAR value of the antenna pattern 115.

Preferably, as shown in FIG. 22, in some embodiments, a spacing distance between the free end 1152a of the first antenna pattern 115a and the free end 1156a of the second antenna pattern 115b is less than an opening width of the first antenna pattern 115a and less than an opening width of the second antenna pattern 115b. Such a configuration can effectively improve the overall the space utilization of the antenna pattern 115. Specifically, the opening width of the first antenna pattern 115a is defined as a length of the line segment GH between the endpoint G and the free end 1152a of the starting end 1151a. The spacing distance between the free end 1152a of the first antenna pattern 115a and the free end 1156a of the second antenna pattern 115b is defined as a length of a line segment GS between the endpoint G of the free end 1152a and the endpoint S of the free end 1156a.

Furthermore, in some embodiments, a main plane of the first antenna pattern 115a and a main plane of the second antenna pattern 115b are arranged parallel to each other or are coplanar. Accordingly, the mutually suppressive relationship between the electromagnetic field formed on the first antenna pattern 115a and the electromagnetic field on the second antenna pattern 115b can be increased, which reduces the proportion of the normal component of the resultant magnetic field formed in the area near the antenna pattern 115 entering the head of the user, and reduces the absorption rate of the resultant magnetic field by the human body, thereby effectively reducing the SAR value of the antenna pattern 115.

Optionally, as shown in FIG. 22, in some embodiments, an arc-to-chord ratio of the second antenna pattern 115b is not less than 2. Specifically, the second antenna pattern 115b is arranged in an overall curved shape. The length of the second antenna pattern 115b is an arc length of an arc KS between the endpoint K of the starting end 1156b and the endpoint S of the free end 1156a of the second antenna pattern 115b along the extension direction. The arc-to-chord ratio of the second antenna pattern 115b is a ratio of the length of the arc KS to a length of the line segment KS. Setting the arc-to-chord ratio of the second antenna pattern 115b to be not less than 2, for example, the arc-to-chord ratio can be 2, 2.5, 3, or other practical values, can effectively increase the bending degree of the second antenna pattern 115b, thereby effectively reducing the space occupancy rate of the second antenna pattern 115b. Optionally, in the present embodiments, the second semi-enclosed structure is arranged in a “U” shape. In some embodiments, the second semi-enclosed structure may be a “C” shape, a “V” shape, or other semi-enclosed curved structures.

Optionally, in some embodiments, the earphone 10 further includes the touch pattern 116 independent of the antenna pattern 115, and at least a portion of the touch pattern 116 is arranged in the first semi-enclosed structure and/or the second semi-enclosed structure, which can effectively improve the space utilization of the touch pattern 116 and the antenna pattern 115, thereby effectively reducing the space occupancy of the touch pattern 116 and the antenna pattern 115.

Optionally, in some embodiments, the antenna pattern 115 is arranged on a side of the second housing 1102 away from the first housing 1101, which can maximize the utilization of the clearance height for the antenna pattern 115 to improve the performance of the antenna pattern 115.

Furthermore, in some embodiments, the main control circuit board 112 and the speaker 111 are stacked in the accommodating space 1103 along the thickness direction X. The main control circuit board 112 is arranged closer to the second housing 1102 than the speaker 111 along the thickness direction X. A radio frequency circuit connected to the feed point 1151b and configured to output the feed signal is arranged on the main control circuit board 112. With such a configuration, a distance between the antenna pattern 115 and the main control circuit board 112 can be effectively reduced, thereby effectively shortening wiring between the main control circuit board 112 and the antenna pattern 115 to improve the space utilization of the housing assembly 110.

The foregoing descriptions are merely partial embodiments of the present disclosure, and are not intended to limit the protection scope of the present disclosure. Any equivalent device or equivalent process transformations made based on the content of the specification and drawings of the present disclosure, or direct or indirect application in other related technical fields, shall similarly fall within the patent protection scope of the present disclosure.

1. An air conduction speaker, comprising:
a diaphragm, a fixing ring, and a frame, wherein
the diaphragm comprises a vibration body and an annular fixing portion connected to the vibration body and arranged around a periphery of the vibration body;
the fixing ring is fixedly connected to the annular fixing portion and sleeved on the frame; and
a first connection length exists between the annular fixing portion and the fixing ring along an axial direction of the air conduction speaker and a second connection length exists between the annular fixing portion and the fixing ring along a radial direction of the air conduction speaker, wherein the first connection length is greater than the second connection length.

2-14. (canceled)

15. An earphone, comprising:
a housing assembly; and
a microphone assembly, wherein
the housing assembly is configured to form an accommodating space, the microphone assembly being disposed in the accommodating space;
two sound inlet holes that connect the accommodating space with an exterior of the housing assembly are provided on the housing assembly, sound inlet ends of the two sound inlet holes being spaced apart from each other;
a mounting groove is provided on an inner surface of the housing assembly, sound outlet ends of the two sound inlet holes communicating with the mounting groove; and
the microphone assembly comprises a sound guiding base and a microphone, wherein a sound guiding channel is provided on the sound guiding base, the sound guiding base is embedded in the mounting groove, a sound inlet end of the sound guiding channel communicates with the sound outlet ends of the two sound inlet holes within the mounting groove, and the microphone is configured to receive sound output from a sound outlet end of the sound guiding channel.

16-45. (canceled)

46. An earphone, comprising an antenna pattern, the antenna pattern including a first antenna pattern and a second antenna pattern, wherein
a feed point for receiving a feed signal is provided on the first antenna pattern;
the first antenna pattern is bent along its extension direction to form a first semi-enclosed structure with a first opening;
the second antenna pattern is coupled to the first antenna pattern to disperse current on the first antenna pattern; and
when viewed in a direction toward a main surface of the first antenna pattern, a projection of the second antenna pattern in a direction opposite to an opening direction of the first antenna pattern at least partially overlaps with the first antenna pattern.

47. The earphone according to claim 46, wherein an arc-to-chord ratio of the first antenna pattern is not less than 2.

48. The earphone according to claim 46, wherein the first antenna pattern and the second antenna pattern are spaced apart, and a grounding point for grounding is provided on the second antenna pattern to serve as a parasitic branch of the first antenna pattern.

49. The earphone according to claim 48, wherein at least a portion of the second antenna pattern is arranged in a wavy shape.

50. The earphone according to claim 48, wherein at least a portion of the second antenna pattern is located inside the semi-enclosed structure.

51. The earphone according to claim 50, wherein
the first antenna pattern comprises a first pattern portion and a second pattern portion arranged side by side and a third pattern portion connecting the first pattern portion and the second pattern portion.

52. The earphone according to claim 51, wherein at least a portion of the second antenna pattern is a touch pattern for detecting a touch signal.

53. The earphone according to claim 52, wherein the second antenna pattern comprises a main portion arranged in a block shape and an extension portion connected to the main portion and arranged in a wavy shape.

54. The earphone according to claim 46, wherein the second antenna pattern is connected to the first antenna pattern with the feed point as a boundary point, and the feed point is configured to simultaneously provide the feed signal to the first antenna pattern and the second antenna pattern.

55. The earphone according to claim 54, wherein the second antenna pattern is bent along an extension direction thereof to form a second semi-enclosed structure with a second opening.

56. The earphone according to claim 55, wherein in an area near the feed point, the first antenna pattern and the second antenna pattern are configured to extend away from each other starting from the feed point.

57. The earphone according to claim 56, wherein
a free end of the first antenna pattern and a free end of the second antenna pattern are arranged adjacent to each other; and
in an area near the free end of the first antenna pattern and the free end of the second antenna pattern, the first antenna pattern and the second antenna pattern are configured to extend toward each other with their respective free ends as terminal points.

58. The earphone according to claim 57, wherein a spacing distance between the free end of the first antenna pattern and the free end of the second antenna pattern is less than an opening width of the first antenna pattern and an opening width of the second antenna pattern.

59. The earphone according to claim 55, wherein an arc-to-chord ratio of the second antenna pattern is not less than 2.

60. The earphone according to claim 55, further comprising a touch pattern, wherein at least a portion of the touch pattern is arranged in the first semi-enclosed structure and/or the second semi-enclosed structure.

61. The earphone according to claim 51, wherein at least a portion of the second antenna pattern is arranged between the first pattern portion and the second pattern portion.

62. The earphone according to claim 51, wherein a projection of the second antenna pattern in a direction opposite to an opening direction of the first antenna pattern at least partially overlaps with the third pattern portion.

63. The earphone according to claim 55, wherein a projection of the first antenna pattern in a direction opposite to an opening direction of the second antenna pattern at least partially overlaps with the second antenna pattern.
